(19) United States
(12) Patent Application Publication
(10) Pub. No.: US 2017/0345297 A1
(43) Pub. Date: Nov. 30, 2017

(54) ROADSIDE COMMUNICATION DEVICE AND DATA RELAY METHOD

(71) Applicant: SUMITOMO ELECTRIC INDUSTRIES, LTD., Osaka-shi, Osaka (JP)

(72) Inventors: Shigeki UMEHARA, Osaka (JP); Hiroshi MATSUMOTO, Osaka (JP); Masafumi KOBAYASHI, Osaka (JP)

(73) Assignee: SUMITOMO ELECTRIC INDUSTRIES, LTD., Osaka-shi, Osaka (JP)

(21) Appl. No.: 15/537,004

(22) PCT Filed: Mar. 9, 2016
(86) PCT No.: PCT/JP2016/057376

§ 371 Date: Jun. 16, 2017

(30) Foreign Application Priority Data
Mar. 10, 2015 (JP) 2015-047058

(51) Int. Cl. G08G 1/09; H04W 28/10; H04W 4/04

(52) U.S. Cl. CPC G08G 1/09; H04W 4/04; H04W 28/10

(57) ABSTRACT

A roadside communication device having a data relay function includes a communication unit that receives mobile object data whose generator is a mobile object; a determining unit that determines whether to perform a thinning process of an amount of the mobile object data received by the communication unit, based on a predetermined determination condition; and a relay unit that relays the mobile object data with the thinning process when a result of the determination by the determining unit is positive, and relays the mobile object data without the thinning process when the result of the determination by the determining unit is negative.

### TECHNICAL FIELD

The present invention relates to a roadside communication device and a data relay method.

This application claims priority to Japanese Patent Application No. 2015-047058 filed Mar. 10, 2015, the entire content of which is incorporated herein by reference.

### BACKGROUND ART

In recent years, as part of intelligent transport systems (ITS), it has been considered to transmit information transmitted and received by vehicle-to-vehicle communication which is a 700 MHz band radio system to a central apparatus, and utilize the information for traffic control by the central apparatus.

Such intelligent transport systems are mainly composed of a plurality of roadside wireless devices which are wireless communication devices on the roadside installed near intersections; and a plurality of on-vehicle wireless devices which are wireless communication devices mounted on vehicles. The plurality of roadside wireless devices are capable of transmitting and receiving information to/from, for example, a central apparatus installed at a traffic control center through communication lines.

In the intelligent transport systems, combinations of communication performed between communication entities are assumed to include roadside-to-vehicle communication where a roadside wireless device radio-transmits various types of information to an on-vehicle wireless device, and vehicle-to-vehicle communication where on-vehicle wireless devices perform radio communication with each other. The roadside wireless device can intercept vehicle data including time information, location information, and the like, which are transmitted and received by vehicle-to-vehicle communication. Therefore, by the roadside wireless device transmitting vehicle data obtained from vehicles, to the central apparatus, the central apparatus can use the vehicle data for traffic signal control (see Non-Patent Literatures 1 and 2).

### CITATION LIST

### Non-Patent Literature

Non-Patent Literature 1: ITS Info-communications Forum, “700 MHz BAND INTELLIGENT TRANSPORT SYSTEMS—Extended Functions Guideline ITS FORUM RC-010 ver. 1.0”, [online], Mar. 15, 2012, [searched on Feb. 5, 2015], Internet <http://www.itsforum.gr.jp/>
Non-Patent Literature 2: ITS Info-communications Forum, “700 MHz BAND INTELLIGENT TRANSPORT SYSTEMS—Experimental nter-vehicle Communication Messages ITS FORUM RC-013 ver. 1.0)”, [online], Mar. 31, 2014, [searched on Feb. 5, 2015], Internet <http://www.itsforum.gr.jp/>

### SUMMARY OF INVENTION

A roadside communication device of the present disclosure is a roadside communication device having a data relay function, and includes a communication unit that receives mobile object data whose generator is a mobile object; a determining unit that determines whether to perform a thinning process of an amount of the mobile object data received by the communication unit, based on a predetermined determination condition; and a relay unit that relays the mobile object data with the thinning process when a result of the determination by the determining unit is positive, and relays the mobile object data without the thinning process when the result of the determination by the determining unit is negative.

A data relay method of the present disclosure is a data relay method for a roadside communication device having a data relay function, and includes a first step of receiving, by a communication unit of the roadside communication device, mobile object data whose generator is a mobile object; a second step of determining, by a determining unit of the roadside communication device, whether to perform a thinning process of an amount of the mobile object data received by the communication unit, based on a predetermined determination condition; and a third step of relaying, by a relay unit of the roadside communication device, the mobile object data with the thinning process when a result of the determination by the determining unit is positive, and relaying the mobile object data without the thinning process when the result of the determination by the determining unit is negative.

### BRIEF DESCRIPTION OF DRAWINGS

FIG. 1 is a perspective view showing an overall configuration of a traffic control system according to a common embodiment.

FIG. 2 is a road plan view of an intersection included in a control area of a central apparatus.

FIG. 3 is a road plan view showing an exemplary configuration of an ITS radio system.

FIG. 4 is a block diagram showing the configurations of a roadside wireless device and an on-vehicle wireless device.

FIG. 5 is a conceptual diagram showing an example of time slots applied to the roadside wireless devices.

FIG. 6 is a diagram showing a data format of a communication frame used for vehicle-to-vehicle communication.

FIGS. 7(a) and 7(b) are diagrams showing the data formats of vehicle data used upon uplink transmission.

FIG. 8 is a flowchart showing the content of a thinning determination process of implementation example 1 of a first embodiment.

FIG. 9 is a flowchart showing the content of a thinning determination process of implementation example 2 of the first embodiment.

FIG. 10 is a flowchart showing the content of a thinning determination process of implementation example 3 of the first embodiment.

FIG. 11 is a flowchart showing the content of a thinning determination process of implementation example 4 of the first embodiment.

FIG. 12 is a flowchart showing the content of a thinning determination process of implementation example 5 of the first embodiment.

FIG. 13 is a flowchart showing the content of a thinning determination process of implementation example 6 of the first embodiment.

FIG. 14 is a flowchart showing the content of a thinning determination process of implementation example 7 of the first embodiment.

FIG. 15 is a table showing the contents of thinning processes of a second embodiment.

FIG. 16 is a table showing the contents of determination conditions of the second embodiment.

FIG. 17 is a road plan view of a plurality of intersections to which one of the thinning processes of the second embodiment is applied.

FIG. 18 is a table showing a variant of the determination conditions of the second embodiment.

### DESCRIPTION OF EMBODIMENTS

### Problem to be Solved by the Present Disclosure

In the above-described intelligent transport systems, when pieces of vehicle data which are transmitted and received by vehicle-to-vehicle communication are aggregated on the central apparatus, it is preferred to collect as much vehicle data as possible in order to perform more advanced traffic signal control.

However, if pieces of vehicle data obtained from a large number of on-vehicle wireless devices which are present in a communication area of a roadside wireless device are transmitted as they are to the central apparatus from the roadside wireless device, then, for example, the amount of data transmission in an uplink direction of a communication line (a metal line under the present conditions) connected to the central apparatus becomes excessive, which may cause an overload of the communication line.

Hence, to suppress the overload of the communication line connected to the central apparatus, it is considered to perform, by the roadside wireless device, a process of removing some of pieces of vehicle data, or a process of discarding some or all of a plurality of pieces of vehicle data without relaying them to the central apparatus (hereinafter, these processes are referred to as “thinning processes”).

However, under conditions where the communication line has room, it is desirable to relay vehicle data without performing a thinning process.

In view of such circumstances, an object is therefore to collect more data while suppressing the overload of the communication line.

### Advantageous Effect of the Present Disclosure

According to the present disclosure, more data can be collected while the overload of a communication line is suppressed.

### Description of Embodiments of the Present Invention

First, the content of an embodiment of the present invention will be listed and described.

(1) A roadside communication device according to an embodiment of the present invention is a roadside communication device having a data relay function, and includes a communication unit that receives mobile object data whose generator is a mobile object; a determining unit that determines whether to perform a thinning process of an amount of the mobile object data received by the communication unit, based on a predetermined determination condition; and a relay unit that relays the mobile object data with the thinning process when a result of the determination by the determining unit is positive, and relays the mobile object data without the thinning process when the result of the determination by the determining unit is negative.

According to the roadside communication device configured in the above-described manner, by the determining unit determining whether to perform the thinning process based on a predetermined determination condition, the relay unit can selectively perform, based on the determination result, relaying of mobile object data with the thinning process and relaying of mobile object data without the thinning process. Hence, when a communication line is not overloaded, a thinning process of mobile object data is not performed, by which more mobile object data can be collected.

(2) In the above-described roadside communication device, it is preferred that the predetermined determination condition include a condition set based on communication conditions of a communication line to be used when the mobile object data is transmitted to a relay destination.

In this case, a determination as to whether to perform a thinning process can be made based on the remaining capacity of the communication line. By this determination, for example, by not performing thinning of mobile object data when the communication line has large remaining capacity, more mobile object data can be collected.

(3) In the above-described roadside communication device, the predetermined determination condition may include a condition set based on a communication processing load of the device.

In this case, a determination as to whether to perform a thinning process can be made based on the communication processing load such as roadside-to-roadside communication or roadside-to-vehicle communication of the device. By this determination, for example, by performing thinning of mobile object data when the communication processing load is small, i.e., when there is room to perform a thinning process other than a communication process, the mobile object data can be securely thinned. In addition, by not performing thinning of mobile object data when the communication processing load is large, more mobile object data can be collected.

(4) In the above-described roadside communication device, the predetermined determination condition may include a condition set based on a specific time slot.

In this case, a determination as to whether to perform a thinning process can be made based on whether the time corresponds to a specific time slot. By this determination, for example, by not performing thinning of mobile object data during a time slot with a small amount of traffic such as nighttime, more mobile object data can be collected.

(5) In the above-described roadside communication device, the predetermined determination condition may include a condition set based on traffic jam conditions on a road.

In this case, a determination as to whether to perform a thinning process can be made based on whether a road is jammed up. By this determination, for example, by not performing thinning of mobile object data when a road is not jammed up, more mobile object data can be collected when no traffic jams.

In addition, reversely to the above-described case, by not performing thinning of mobile object data when a road is jammed up, more mobile object data required to grasp traffic jam conditions, etc., can be collected.

(6) In the above-described roadside communication device, the predetermined determination condition may include a condition set based on a specific mobile object.

In this case, a determination as to whether to perform a thinning process can be made based on whether a mobile object that is the generator of mobile object data corresponds to a specific vehicle such as an emergency vehicle. By this determination, it can be configured, for example, such that thinning of mobile object data is performed when the generator of the mobile object data is a private passenger vehicle other than the specific vehicle, and thinning of mobile object data is not performed when the generator of the mobile object data corresponds to the specific vehicle. By this, more mobile object data of the specific vehicles can be collected.

(7) In the above-described roadside communication device, the predetermined determination condition may include a condition set based on a specific event occurring on a road.

In this case, a determination as to whether to perform a thinning process can be made based on whether a specific event such as an accident is occurring on a road. By this determination, for example, by not performing thinning of mobile object data when an accident has occurred on a road, more mobile object data required to grasp the behavior, traffic jam conditions, etc., of vehicles which are different than usual on the road where the accident has occurred can be collected.

In addition, reversely to the above-described case, by performing thinning of mobile object data when an accident has occurred on a road, even if the road is congested due to the accident, the communication line can be suppressed from becoming overloaded.

(8) In the above-described roadside communication device, the predetermined determination condition may include a condition set based on at least one of positioning accuracy, a location, and a state of the mobile object.

In this case, a determination as to whether to perform a thinning process can be made based on any of the positioning accuracy, location, and state of a mobile object. In this determination, for example, when a mobile object has high positioning accuracy, thinning of mobile object data thereof is not performed, by which more mobile object data with high positioning accuracy of mobile objects can be collected.

In addition, in the above-described determination, for example, near an intersection where a main road and a sub-road are connected, when a mobile object is located on the sub-road, a thinning process of mobile object data thereof is performed, and when a mobile object is located on the main road, a thinning process of mobile object data thereof is not performed. By this, more mobile object data of mobile objects traveling the main road can be collected.

In addition, reversely to the above-described case, by performing, when a mobile object is located on the main road, a thinning process of mobile object data thereof, the communication line can be suppressed from becoming overloaded when pieces of mobile object data are relayed from mobile objects traveling the main road with a large amount of traffic.

In addition, in the above-described determination, for example, when the state of a mobile object is “traveling”, a thinning process of mobile object data thereof is not performed, by which more mobile object data obtained from traveling mobile objects can be collected.

(9) In the above-described roadside communication device, it is preferred that the communication unit be capable of receiving a control instruction including the predetermined determination condition from an external device, and the determining unit determine whether to perform the thinning process, based on the received control instruction.

In this case, by the determining unit using a predetermined determination condition included in a control instruction which is received from an external device (e.g., a central apparatus), the determining unit can easily make a determination as to whether to perform a thinning process.

(10) In the above-described roadside communication device, it is preferred that the relay unit be capable of performing a plurality of thinning processes having different processing contents, and the determining unit determine whether to perform each of the thinning processes, based on a plurality of predetermined determination conditions set for each of the plurality of thinning processes.

In this case, since the relay unit can perform a plurality of thinning processes having different processing contents, the relay unit can select and perform optimal thinning processes by which more mobile object data can be collected, according to traffic conditions.

(11) In the above-described roadside communication device, it is preferred that the plurality of thinning processes have processing contents with different thinning levels, the processing contents being such that an amount of thinning increases gradually as a thinning level changes gradually.

In this case, the relay unit can selectively perform a plurality of thinning processes where the amount of thinning of mobile object data increases gradually as the thinning level changes gradually. Therefore, when a thinning process of mobile object data is performed, by performing a thinning process with a small amount of thinning, more mobile object data can be collected.

(12) In the above-described roadside communication device, it is preferred that the mobile object data received by the communication unit include a plurality of data items, the plurality of thinning processes include a process of removing a data item of a predetermined amount of data from the mobile object data, and an amount of data of the data item serving as a removal target in the plurality of thinning processes be set so as to increase gradually as a thinning level of each of the thinning processes changes gradually.

In this case, when the relay unit performs a thinning process of mobile object data, for example, the relay unit can reduce the amount of data of a data item to be removed from the mobile object data as the thinning level gets lower. Therefore, when a thinning process of mobile object data is performed, by setting a low thinning level, the number of pieces of mobile object data to be transmitted to a relay destination can be increased, and thus, more mobile object data can be collected.

(13) In the above-described roadside communication device, the relay unit may transmit the mobile object data to the relay destination at a predetermined time interval, the plurality of thinning processes may include a process of discarding at least some of a plurality of pieces of mobile object data received by the communication unit, by increasing the time interval, and the time interval of the plurality of thinning processes may be set so as to increase gradually as the thinning level of each of the thinning processes changes gradually.

In this case, when the relay unit performs a thinning process of mobile object data, for example, the relay unit reduces the above-described time interval as the thinning level gets lower, by which the number of pieces of mobile object data to be transmitted to the relay destination can be increased. Therefore, when a thinning process of mobile object data is performed, by setting a low thinning level, more mobile object data can be collected.

(14) In the above-described roadside communication device, the mobile object data received by the communication unit may include information indicating positioning accuracy of the mobile object, the mobile object being the generator of the mobile object data, the plurality of thinning processes may include a process of discarding at least some of a plurality of pieces of mobile object data received by the communication unit, by setting a level of the positioning accuracy as a transmission condition to the relay destination, and the level of the positioning accuracy serving as the transmission condition in the plurality of thinning processes may be set so as to increase gradually as the thinning level of each of the thinning processes changes gradually.

In this case, when the relay unit performs a thinning process of mobile object data, for example, the relay unit reduces the positioning accuracy of a mobile object serving as the transmission condition as the thinning level gets lower, by which the number of pieces of mobile object data to be transmitted to the relay destination can be increased. Therefore, when a thinning process of mobile object data is performed, by setting a low thinning level, more mobile object data can be collected.

(15) In the above-described roadside communication device, the mobile object data may include information indicating a location of the mobile object, the mobile object being the generator of the mobile object data, the plurality of thinning processes may include a process of discarding the mobile object data obtained from the mobile object, when the location of the mobile object is included in a predetermined region, and a size of the predetermined region of the plurality of thinning processes may be set so as to increase gradually as the thinning level of each of the thinning processes changes gradually.

In this case, when the relay unit performs a thinning process of mobile object data, for example, the relay unit reduces the above-described predetermined region as the thinning level gets lower, by which the number of pieces of mobile object data to be transmitted to the relay destination can be increased. Therefore, when a thinning process of mobile object data is performed, by setting a low thinning level, more mobile object data can be collected.

(16) In the above-described roadside communication device, the mobile object data may include information indicating an event of the mobile object, the mobile object being the generator of the mobile object data, the plurality of thinning processes may include a process of discarding mobile object data obtained, from the mobile object, in a predetermined number of event sections of the mobile object, and a number of the event sections of the plurality of thinning processes may be set so as to increase gradually as the thinning level of each of the thinning processes changes gradually.

In this case, when the relay unit performs a thinning process of mobile object data, for example, the relay unit reduces the number of the above-described event sections serving as thinning targets as the thinning level gets lower, by which the number of pieces of mobile object data to be transmitted to the relay destination can be increased. Therefore, when a thinning process of mobile object data is performed, by setting a low thinning level, more mobile object data can be collected.

(17) In the above-described roadside communication device, the mobile object data may include information capable of identifying a moving route of the mobile object, the mobile object being the generator of the mobile object data, the plurality of thinning processes may include a process of discarding the mobile object data obtained from the mobile object, when the mobile object is moving on a predetermined number of moving routes, and a number of the moving routes of the plurality of thinning processes may be set so as to increase gradually as the thinning level of each of the thinning processes changes gradually.

In this case, when the relay unit performs a thinning process of mobile object data, for example, the relay unit reduces the number of the above-described moving routes serving as thinning targets as the thinning level gets lower, by which the number of pieces of mobile object data to be transmitted to the relay destination can be increased. Therefore, when a thinning process of mobile object data is performed, by setting a low thinning level, more mobile object data can be collected.

(18) A data relay method of the present embodiment is a data relay method performed by the above-described roadside communication device. Therefore, the data relay method of the present embodiment provides the same functions and effects as the above-described roadside communication device.

### Details of the Embodiments of the Present Invention

Details of embodiments of the present invention will be described below with reference to the drawings. Note that at least some of the embodiments described below may be arbitrarily combined.

### Definitions of Terms

In describing the details of the embodiments, first, terms used in the embodiments are defined.

“Mobile object”: A collective term for objects that pass through passable regions such as public roads, private roads, and parking lots. The mobile objects of the embodiments include “vehicles” which will be described later and pedestrians.

“Vehicle”: Vehicles in general that can pass through roads. Specifically, the vehicles refer to vehicles defined by the Road Traffic Law. The vehicles defined by the Road Traffic Law include automobiles, motorbikes, light vehicles, and trolleybuses.

“Traffic signal controller”: Refers to a controller that controls timing at which signal light units at an intersection are turned on and off.

“Roadside detector”: Refers to a sensor device installed to sense the passing states of vehicles. The roadside detectors include vehicle sensors, surveillance cameras, optical beacons, and the like.

“Roadside communication device”: Refers to a communication device installed on the roadside (infrastructure side). The roadside communication devices include roadside wireless devices which will be described later. When an information relay device is interposed for wired communication between a roadside wireless device and a central apparatus, the information relay device is also included in the roadside communication device.

“Wireless communication device”: Refers to a device that has a communication function of transmitting and receiving, by radio, communication frames conforming to a predetermined protocol and that serves as a transmitting and receiving entity for radio communication. The wireless communication devices include roadside wireless devices and mobile radios which will be described later.

“Roadside wireless device”: Refers to a wireless communication device installed on the roadside (infrastructure side). In the embodiments, the roadside wireless device refers to a wireless communication device capable of performing roadside-to-roadside communication with another roadside wireless device and roadside-to-vehicle communication with an on-vehicle wireless device.

“Mobile radio”: Refers to a wireless communication device mounted on a mobile object (“carried by” in the case of a passenger and a pedestrian). The mobile radios of the embodiments include on-vehicle wireless devices and portable terminals which will be described later.

“On-vehicle wireless device”: Refers to a wireless communication device permanently or temporarily mounted on a vehicle. A portable terminal such as a mobile phone or a smartphone carried on a vehicle by a passenger also corresponds to an on-vehicle wireless device if the portable terminal can perform radio communication with a roadside wireless device.

“Portable terminal”: Refers to a wireless communication device carried by a vehicle passenger or a pedestrian. Specifically, mobile phones, smartphones, tablet computers, notebook personal computers, etc., correspond to the portable terminals.

“Communication frame”: A collective term for PDUs (Protocol Data Units) used for radio communication by wireless communication devices and PDUs used for wired communication by roadside communication devices including roadside wireless devices.

“Mobile object data”: Refers to data whose generators are a vehicle and a portable terminal. The mobile object data includes vehicle data which will be described later.

“Vehicle data”: Refers to data whose generator is a vehicle. For example, data such as a time, a vehicle location, and an azimuth measured by the vehicle corresponds to the vehicle data.

“Roadside data”: Refers to data whose generators are a traffic signal controller, a roadside detector, and a roadside communication device. For example, control signal execution information generated by a traffic signal controller and detection information measured by a roadside detector correspond to the roadside data.

### Common Embodiment

<Overall Configuration of a System>

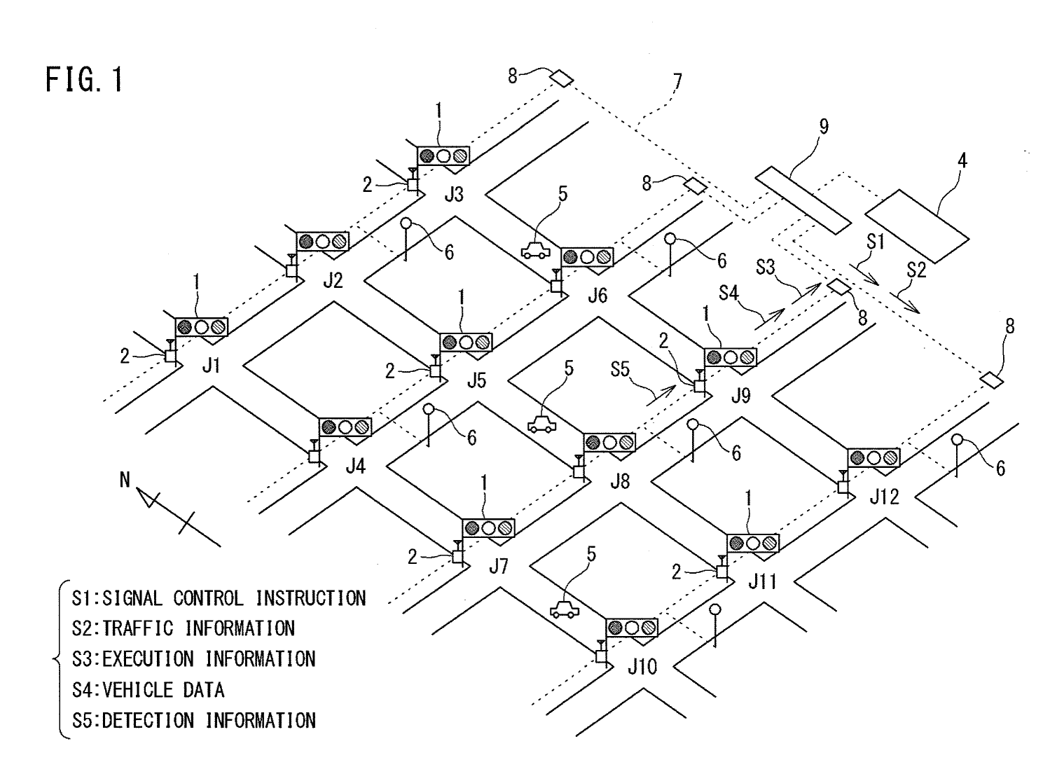

FIG. 1 is a perspective view showing an overall configuration of a traffic control system according to a common embodiment.

Although FIG. 1 exemplifies, as an example of a road structure, a square-pattern structure where a plurality of roads in a north-south direction and an east-west direction intersect each other, the road structure is not limited thereto.

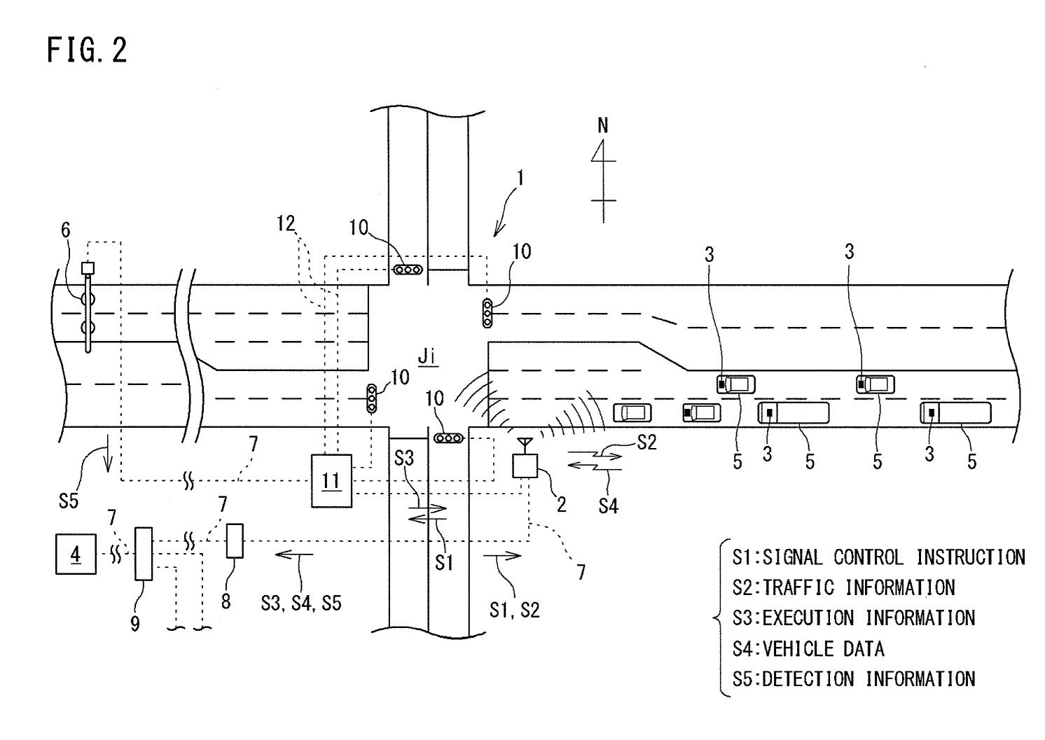

As shown in FIG. 1, a traffic signal control system of the embodiment includes traffic signal units 1, roadside wireless devices 2, on-vehicle wireless devices 3 (see FIGS. 2 to 4), a central apparatus 4, vehicles 5 having mounted thereon the on-vehicle wireless devices 3, roadside detectors 6, and the like.

The traffic signal units 1 and the roadside wireless devices 2 are installed at respective intersections Ji (in FIG. 1, i=1 to 12) included in a control area of the central apparatus 4, and are connected to multi-stage routers 8 and 9 through communication lines 7. The routers 8 of the first stage which are the closer ones to the intersections are provided in a plural number in the control area.

To each router 8 of the first stage are connected traffic signal units 1 and roadside wireless devices 2 provided at respective intersections Ji (e.g., i=1 to 3). Communication lines 7 extending to the central apparatus 4 side from the plurality of routers 8 are aggregated at the router 9 of the second stage, and the router 9 of the second stage is further connected to the central apparatus 4 by a communication line 7.

The communication lines 7 are made of, for example, metal lines. For a communication system of communication devices using the communication lines 7 as communication media, an ISDN (Integrated Services Digital Network) system is adopted.

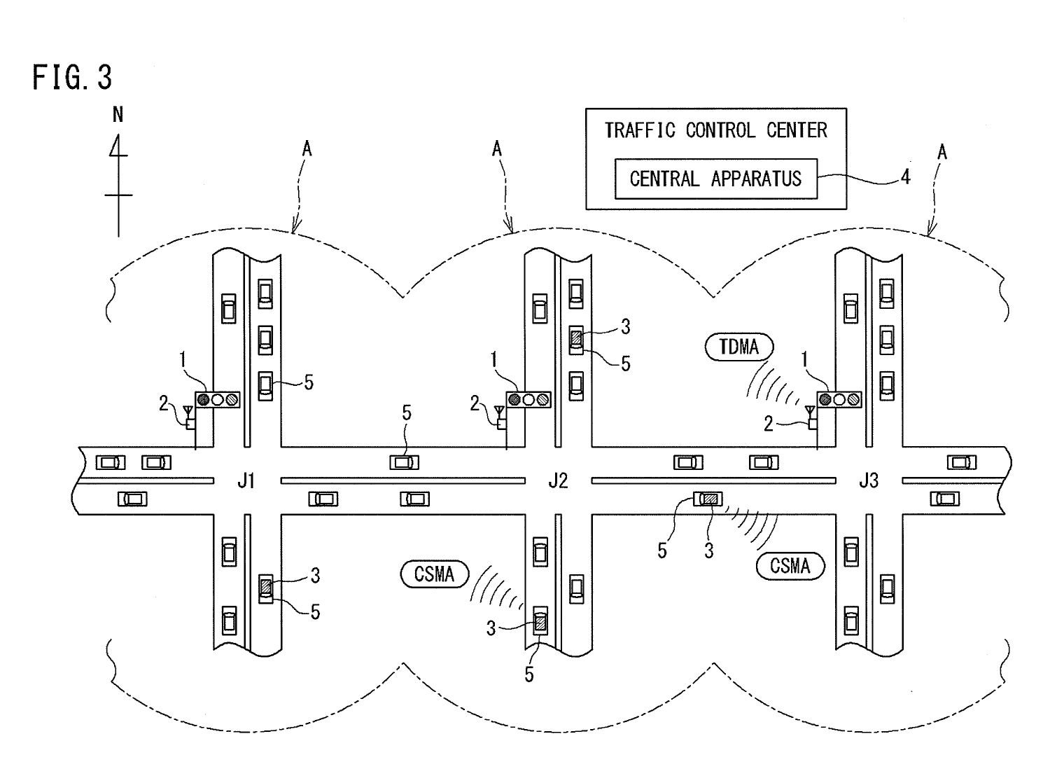

The central apparatus 4 is installed in a traffic control center (see FIG. 3). The central apparatus 4 forms a LAN (Local Area Network) with the traffic signal units 1 and the roadside wireless devices 2 at the intersections Ji which are included in its control area.

Therefore, the central apparatus 4 can perform two-way communication with each traffic signal unit 1 and each roadside wireless device 2. Note that the central apparatus 4 may be installed on a road instead of in the traffic control center.

The roadside detectors 6 are installed at various locations on roads in the control area for the main purpose of counting the number of vehicles flowing into the intersections Ji.

The roadside detectors 6 include at least one of, for example, a vehicle sensor that senses vehicles 5 passing just thereunderneath by an ultrasonic wave, a surveillance camera that films the passing conditions of vehicles 5 in chronological order, and an optical beacon that performs optical communication by near infrared rays with vehicles 5.

As shown in FIG. 1, information to be transmitted to the communication line 7 by the central apparatus 4 (hereinafter, referred to as “downlink information”) includes a signal control instruction S1, traffic information S2, and the like.

The signal control instruction S1 is information indicating the timing of changing the lamp color at a traffic signal unit 1 (e.g., a cycle start time and the number of step execution seconds), and is transmitted to a traffic signal controller 11 (see FIG. 2). The traffic information S2 is, for example, traffic jam information and traffic control information, and is transmitted to the roadside wireless devices 2, the optical beacons of the roadside detectors 6, etc.

Information received by the central apparatus 4 through the communication lines 7 (hereinafter, referred to as “uplink information”) includes control signal execution information S3, vehicle data S4, detection information S5, and the like.

The signal control execution information (hereinafter, referred to as “execution information”) S3 is information indicating the actual results of control that is actually performed by a traffic signal controller 11 in the last cycle. Therefore, the generator of the execution information S3 is the traffic signal controller 11.

The vehicle data S4 is, as described above, data whose generator is a vehicle 5. The vehicle data S4 includes at least the time and location of the vehicle 5 at a time point of generation of the data. Therefore, by arranging pieces of location information of a plurality of pieces of vehicle data S4 for the same vehicle ID in chronological order, probe data that allows to identify a traveling path of a vehicle 5 is obtained.

The detection information S5 is information indicating measurement results obtained by a roadside detector 6, and includes sensed information of a vehicle sensor, image data of a surveillance camera, etc. Therefore, the generator of the detection information S5 is the roadside detector 6.

<Connection Form of Communication Lines>

FIG. 2 is a road plan view of an intersection Ji included in the control area of the central apparatus 4.

As shown in FIG. 2, a traffic signal unit 1 includes a plurality of signal light units 10 that show flow-in roads at the intersection Ji information as to whether there is the right to pass through; and a traffic signal controller 11 that controls timing at which the signal light units 10 are turned on and off. The signal light units 10 are connected to the traffic signal controller 11 through predetermined signal control lines 12.

A roadside wireless device 2 is installed near the intersection Ji so that the roadside wireless device 2 can perform radio communication with vehicles 5 that pass through roads branching from the intersection Ji. Therefore, the roadside wireless device 2 can receive radio waves transmitted from vehicles 5 that perform vehicle-to-vehicle communication on the roads by on-vehicle wireless devices 3.

A roadside detector 6 is connected to the traffic signal controller 11 through a communication line 7 in a communicable manner, and the traffic signal controller 11 is connected to the roadside wireless device 2 through a communication line 7 in a communicable manner. Note that the traffic signal controller 11 may be connected to a router 8 without through the roadside wireless device 2.

The traffic signal controller 11 transmits generated execution information S3 to the roadside wireless device 2, and the roadside detector 6 transmits measured detection information S5 to the roadside wireless device 2 through the traffic signal controller 11.

When the roadside wireless device 2 receives the execution information S3 and the detection information S5, the roadside wireless device 2 uplink-transmits the information S3 and S5 to the central apparatus 4. In addition, when the roadside wireless device 2 receives vehicle data S4, the roadside wireless device 2 uplink-transmits the vehicle data S4 to the central apparatus 4.

When downlink information from the central apparatus 4 includes a signal control instruction S1, the roadside wireless device 2 transfers the received signal control instruction S1 to the traffic signal controller 11.

In addition, when downlink information from the central apparatus 4 includes traffic information S2, the roadside wireless device 2 radio-transmits the traffic information S2 by broadcast so as to provide the received traffic information S2 to vehicles 5.

The execution information S3, vehicle data S4, and detection information S5 which are uplink-transmitted by the roadside wireless device 2 are transmitted to the central apparatus 4 by wired communication using communication lines 7 via the router 8 of the first stage and the router 9 of the second stage.

Note that, in FIG. 2, by connecting a communication line 7 on the upstream side of the traffic signal controller 11 to the router 8, the traffic signal controller 11 may transmit the execution information S3 and the detection information S5 to the central apparatus 4 without through the roadside wireless device 2.

Meanwhile, if the mounting rate of the on-vehicle wireless devices 3 increases with progress in the proliferation of an ITS radio system, then the amount of vehicle data S4 obtained by the roadside wireless device 2 also increases. Due to this, the amount of data to be uplink-transmitted to the communication line by the roadside wireless device 2 increases, and accordingly, the communication line 7 is expected to become overloaded.

Under the present conditions, particularly, since the communication line 7 is made of a relatively low-speed ISDN line, it is considered to be highly possible that the communication line 7 becomes overloaded with an increase in the amount of vehicle data S4.

In addition, in the example of FIG. 2, the router 9 of the second stage is smaller in number than the router 8 of the first stage and the communication lines 7 are aggregated at the router 9 of the second stage. Thus, communication in an uplink direction between the router 9 of the second stage and the central apparatus 4 is considered to become a bottleneck.

Hence, in the embodiment, in order to suppress the overload of the communication lines 7 that transmit uplink information to the central apparatus 4 (particularly, the communication line 7 directly connected to the central apparatus 4), the roadside wireless device 2 performs a data thinning process when relaying uplink information, the details of which will be described later.

<Central Apparatus>

The central apparatus 4 has a control unit composed of a workstation (WS), a personal computer (PC), or the like. The control unit comprehensively performs, for example, collection, processing, and recording of various types of information S3 to S5 which are uplink-transmitted from the roadside wireless devices 2 in the control area, and signal control and information provision based on the information S3 to S5.

Specifically, the central apparatus 4 can perform, on the traffic signal units 1 at the intersections Ji belonging to the control area, “route control” where a group of traffic signal units 1 on the same road is controlled, “wide area control (plane control)” where the route control is extended to a road network, etc.

The central apparatus 4 has a communication unit that performs communication using a communication line 7. The communication unit of the central apparatus 4 performs downlink transmission of a signal control instruction S1 and traffic information S2 and uplink reception of execution information S3, vehicle data S4, and detection information S5.

The control unit of the central apparatus 4 can perform the above-described route control and wide area control, using uplink information transmitted from the roadside wireless devices 2 at the respective intersections Ji.

In addition, the control unit of the central apparatus 4 downlink-transmits a signal control instruction S1 every computation cycle of route control, etc. (e.g., 2.5 minutes), and downlink-transmits traffic information S2 every predetermined cycle (e.g., 5 minutes).

<Radio Communication System, Etc.>

FIG. 3 is a road plan view showing an exemplary configuration of an ITS radio system.

In FIG. 3, for simplification of the drawing, all roads are depicted to have one lane in one direction; however, for example, when a main road runs in the east-west direction and a sub-road runs in the north-south direction (see FIG. 2), the road structure is not limited to that shown in FIG. 3.

As shown in FIG. 3, the ITS radio system of the embodiment is a radio communication system for adopting pieces of vehicle data S4 which are transmitted and received by vehicle-to-vehicle communication between vehicles 5, into traffic control of the central apparatus 4.

Specifically, the ITS radio system of the embodiment includes a plurality of roadside wireless devices 2 capable of performing radio communication with on-vehicle wireless devices 3; and the on-vehicle wireless devices 3 that perform radio communication with other wireless communication devices 2 and 3 by a carrier sense system.

The roadside wireless devices 2 are installed at respective intersections Ji, and mounted on signal light unit poles of traffic signal units 1. The on-vehicle wireless devices 3 are mounted on some or all of the vehicles 5 traveling the roads.

An on-vehicle wireless device 3 mounted on a vehicle 5 can receive, in an area where radio waves transmitted from a roadside wireless device 2 reach, the transmitted radio waves. In addition, the roadside wireless device 2 can receive, in an area where radio waves transmitted from the An on-vehicle wireless device 3 reach, the transmitted radio waves.

Here, it is assumed that the distance at which the transmitted radio waves of the An on-vehicle wireless device 3 reach is less than or equal to the distance at which the transmitted radio waves of the roadside wireless device 2 reach. Therefore, the roadside wireless device 2 can receive radio waves transmitted from An on-vehicle wireless devices 3 located within a range of a communication area A which is a downlink area thereof.

Combinations of communication entities in the ITS radio system are classified into “vehicle-to-vehicle communication” which is communication between on-vehicle wireless devices 3, “roadside-to-vehicle communication” which is communication between a roadside wireless device 2 and an on-vehicle wireless device 3, and “roadside-to-roadside communication” which is communication between roadside wireless devices 2.

For a multiple access system that allows the above-described three types of communication to coexist, frequency division multiple access (FDMA), code division multiple access (CDMA), etc., can be adopted.

In a case of improving the priority of transmission by the roadside wireless devices 2, a multiple access system that follows the “700 MHz band intelligent transport systems standard (ARIB STD-T109)” may be adopted. In the embodiment, it is assumed that this system is adopted.

The above-described multiple access system following the standard is a system in which a time slot dedicated for transmission by roadside wireless devices 2 is assigned by a TDMA (Time Division Multiple Access) system, and a time slot other than the time slot dedicated for the roadside is assigned to vehicle-to-vehicle communication by a CSMA/CA (Carrier Sense Multiple Access/Collision Avoidance) system.

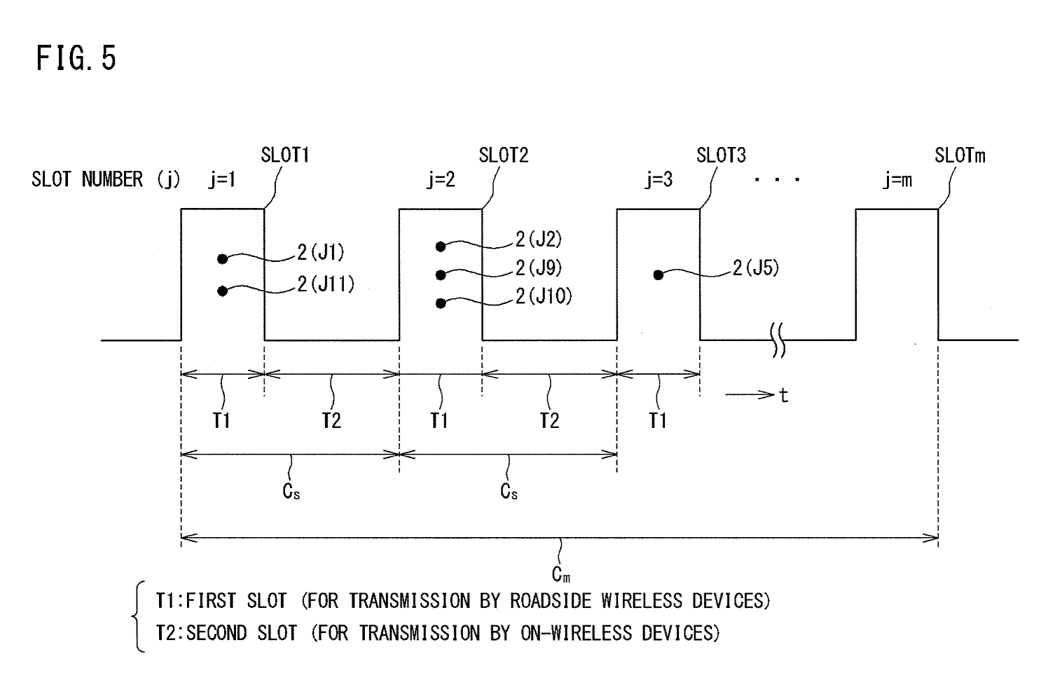

According to this system, roadside wireless devices 2 do not perform radio transmission during a time slot (a second slot T2 of FIG. 5) other than a time slot dedicated therefor (a first slot T1 of FIG. 5). Namely, the time slot other than the time slot for the roadside wireless devices 2 is open as a transmission time period by the CSMA system for on-vehicle wireless devices 3.

In addition, a roadside wireless device 2 receives radio waves transmitted by vehicle-to-vehicle communication, without negotiating with on-vehicle wireless devices 3, and thereby obtains information exchanged by the vehicle-to-vehicle communication.

Furthermore, in the roadside wireless devices 2, in order to prevent radio waves transmitted from a plurality of roadside wireless devices 2 from simultaneously reaching an on-vehicle wireless device 3, causing interference, roadside wireless devices 2 at adjacent intersections Ji use different time slots.

Hence, each roadside wireless device 2 has a time synchronization function of synchronizing a time with other roadside wireless devices 2. Time synchronization of the roadside wireless device 2 is performed by, for example, GPS synchronization where a time of the roadside wireless device 2 is synchronized with a GPS time, or air synchronization where a clock of the roadside wireless device 2 is synchronized with a transmit signal from another roadside wireless device 2.

<Configuration of the Roadside Wireless Device>

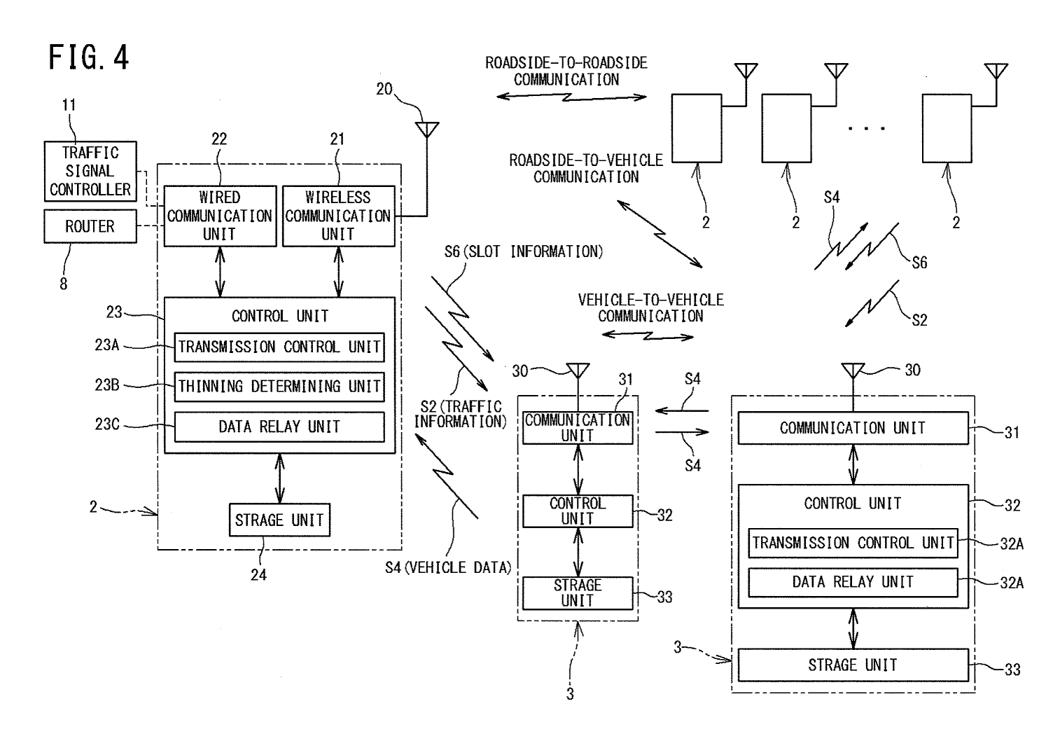

FIG. 4 is a block diagram showing the configurations of a roadside wireless device 2 and an on-vehicle wireless device 3.

The roadside wireless device 2 includes a wireless communication unit 21 having connected thereto an antenna 20 for radio communication; a wired communication unit 22 that performs communication with the central apparatus 4; a control unit 23 composed of, for example, a processor (CPU: Central Processing Unit) that performs those communication control; and a storage unit 24 composed of memory devices such as a ROM and a RAM connected to the control unit 23.

The storage unit 24 of the roadside wireless device 2 stores a computer program for communication control which is performed by the control unit 23, various types of data received from other wireless communication devices 2 and 3, etc.

The control unit 23 of the roadside wireless device 2 has, as functional units achieved by executing the above-described computer program, a transmission control unit 23A that controls the transmission timing of the wireless communication unit 21; a thinning determining unit 23B that determines whether to perform a thinning process of data received by the wireless communication unit 21; and a data relay unit 23C that performs a relaying process of data received by the communication units 21 and 22.

The thinning determining unit 23B of the roadside wireless device 2 determines whether to perform a thinning process of vehicle data S4 received by the wireless communication unit 21, based on a predetermined determination condition. The determination condition is included in a control instruction which is transmitted to the wired communication unit 22 of the roadside wireless device 2 from the central apparatus 4.

Therefore, the thinning determining unit 23B determines whether to perform a thinning process, based on a control instruction received by the wired communication unit 22 from the central apparatus 4. The details of the determination condition will be described later.

As such, the thinning determining unit 23B can easily determine whether to perform a thinning process, by using a predetermined determination condition included in a control instruction received from the central apparatus 4.

Note that the determination condition may be recorded in advance in the storage unit 24 of the roadside wireless device 2.

The data relay unit 23C of the roadside wireless device 2 allows the storage unit 24 to temporarily store traffic information S2 which is received by the wired communication unit 22 from the central apparatus 4, and allows the wireless communication unit 21 to broadcast the traffic information S2.

In addition, the data relay unit 23C allows the storage unit 24 to temporarily store vehicle data S4 which is received by the wireless communication unit 21, and transfers the vehicle data S4 to the central apparatus 4 through the wired communication unit 22 or transfers the vehicle data S4 to another roadside wireless device 2 through the wireless communication unit 21.

Upon transferring the vehicle data S4 to the central apparatus 4 or another roadside wireless device 2, when a determination result of the thinning determining unit 23B is positive, the data relay unit 23C performs a thinning process of the vehicle data S4 and then transfers the vehicle data S4, and when the determination result of the thinning determining unit 23B is negative, the data relay unit 23C transfers the vehicle data S4 without performing a thinning process of the vehicle data S4.

As described above, by the thinning determining unit 23B determining whether to perform a thinning process based on a predetermined determination condition, the data relay unit 23C can selectively perform, based on the determination result, relaying of vehicle data S4 with a thinning process and relaying of vehicle data S4 without a thinning process. Hence, when the communication lines 7 are not overloaded, a thinning process of vehicle data S4 is not performed, by which more vehicle data S4 can be collected.

The transmission control unit 23A of the roadside wireless device 2 performs radio transmission for a predetermined transmission time period during a time slot T1 with a predetermined slot number j which is assigned to the roadside wireless device 2 (see FIG. 5: the time slot T1 may be hereinafter referred to as a “slot j”), while synchronizing transmission timing with other devices.

The storage unit 24 of the roadside wireless device 2 stores slot information S6 including, for example, the following information a) and b). The slot information S6 is individually set for each roadside wireless device 2.

a) A slot number j being used by the roadside wireless device (j=1 to m) (see FIG. 5)

b) The start time and duration of a first slot T1 with the slot number j (see FIG. 5)

The storage unit 24 of the roadside wireless device 2 stores a transmission time period for the amount of information to be transmitted by the roadside wireless device 2 through radio waves (the amount of transmit data); and a transmission start time thereof. The transmission start time and transmission time period are individually set for each roadside wireless device 2 so as to be present in a time slot T1 assigned to the roadside wireless device 2.

The transmission control unit 23A generates a transmit signal with the length of the set transmission time period and allows the wireless communication unit 21 to transmit the transmit signal at the set transmission start time.

The transmission time period of the roadside wireless device 2 may be set to the maximum duration (slot length) of the time slot T1 assigned to the roadside wireless device 2, but taking into account synchronization shifts from other wireless communication devices 2 and 3, the information processing time of the receiving end, etc., it is preferred that the transmission time period be set to be a bit shorter than the slot length, with a predetermine margin (e.g., a guard time on the order of 10 μs).

The transmission time period of the roadside wireless device 2 is adjustable to any time length within the range of the slot length assigned to the roadside wireless device 2, and can be adjusted to a shorter period of time than the slot length.

Of the transmission start time and transmission time period of a transmit signal, the transmission start time may be autonomously generated by the transmission control unit 23A of each roadside wireless device 2, based on a start time of a slot j included in slot information S6 of the roadside wireless device 2.

When the transmission control unit 23A of the roadside wireless device 2 sends out a communication frame including slot information S6 to a communication area A of the roadside wireless device 2, the transmission control unit 23A allows the wireless communication unit 21 to broadcast the communication frame including a timestamp of the current time.

When an on-vehicle wireless device 3 receives the communication frame including the slot information S6 and the timestamp, the on-vehicle wireless device 3 performs radio transmission during a time slot (a second slot T2 of FIG. 5) other than a first slot T1 with a slot number j which is described in the slot information S6, with reference to the current time of the timestamp.

Note that if a main cycle Cm which will be described later (see FIG. 5) is included in slot information S6, then the start time of a slot j and the current time of a timestamp can be represented by relative times in the main cycle Cm. In that case, the number of bits of the slot information S6 can be reduced compared to a case of representing the times by absolute times.

Slot information S6 generated by one roadside wireless device 2 may include at least time information of a slot j used by the roadside wireless device 2.

However, when the roadside wireless device 2 knows of slot information S6 used by another roadside wireless device 2 by roadside-to-roadside communication or communication with the central apparatus 4, the roadside wireless device 2 may transmit the slot information S6 of another roadside wireless device 2 as well.

<Content of Time Slots>

FIG. 5 is a conceptual diagram showing an example of time slots applied to the roadside wireless devices 2.

As shown in FIG. 5, time slots applied to the roadside wireless devices 2 include a first slot T1 and a second slot T2. A total period of the time slots is repeated in certain slot cycles Cs.

The first slot T1 of each slot cycle Cs is a time slot for roadside wireless devices 2. During this time slot, radio transmission by the roadside wireless devices 2 is allowed.

The first slot T1 is provided with a slot number j. The slot number j is cyclically incremented (may be decremented).

The second slot T2 is a time slot for on-vehicle wireless devices 3. This time slot is open for radio transmission by on-vehicle wireless devices 3, and thus, the transmission control units 23A of the roadside wireless devices 2 do not perform radio transmission during the second slot T2.

The slot number i gets back to an initial number (j=1 in the example in the drawing) when reaching a predetermined number m. Therefore, when m slot cycles Cs form a main cycle Cm, a first slot T1 with each of the slot numbers i to m occurs once every main cycle Cm.

Note that the time lengths of the cycles Cs and Cm and the total number m of slot cycles Cs can be set by a system operator as appropriate, but in the embodiment, as an example, Cs=10 ms, Cm=100 ms, and m=10.

In FIG. 5, a black filled circle described in each first slot T1 with the slot number j=1 to 3 represents a roadside wireless device 2 whose transmission time period is assigned to that first slot T1 with the slot number j. Therefore, slots 1 and 2 each having a plurality of black filled circles indicate that the transmission time periods of a plurality of roadside wireless devices 2 overlap each other and the slot number j is shared by the plurality of roadside wireless devices 2.

In the example of FIG. 5, the slot 1 is shared by two roadside wireless devices 2 installed at an intersection J1 and an intersection J11, and the slot 2 is shared by three roadside wireless devices 2 installed at an intersection J2, an intersection J9, and an intersection J10.

<Configuration of the On-Vehicle Wireless Device>

Referring back to FIG. 4, the on-vehicle wireless device 3 includes a communication unit 31 connected to an antenna 30 for radio communication; a control unit 32 composed of, for example, a processor that performs communication control on the communication unit 31; and a storage unit 33 composed of memory devices such as a ROM and a RAM connected to the control unit 32.

The storage unit 33 of the on-vehicle wireless device 3 stores a computer program for communication control which is performed by the control unit 32, various types of data received from other wireless communication devices 2 and 3, etc.

The control unit 32 of the on-vehicle wireless device 3 is a control unit that allows the communication unit 31 to perform radio communication by a carrier sense system for vehicle-to-vehicle communication, and does not have a communication control function by a time division multiplexing system like the roadside wireless device 2.

Therefore, the communication unit 31 of the on-vehicle wireless device 3 senses a reception level of a predetermined carrier frequency at all times, and is configured not to perform radio transmission when the value of the reception level is greater than or equal to a given threshold value, and to perform radio transmission only when the value reaches less than the threshold value.

The control unit 32 of the on-vehicle wireless device 3 has, as functional units achieved by executing the above-described computer program, a transmission control unit 32A that controls the radio transmission timing of the communication unit 31; and a data relay unit 32B that performs a relaying process of data received by the communication unit 31.

The transmission control unit 32A of the on-vehicle wireless device 3 identifies a time slot for radio transmission that is allowed for the on-vehicle wireless device 3, according to a start time included in slot information S6 obtained from a roadside wireless device 2 and the slot information S6, and allows the communication unit 31 to perform radio transmission only during this time slot.

Namely, the transmission control unit 32A extracts slot information S6 and a timestamp which are generated by a roadside wireless device 2, from a communication frame directly received from the roadside wireless device 2 or received via another on-vehicle wireless device 3.

Then, the transmission control unit 32A allows the communication unit 31 to perform radio transmission by a carrier sense system only during a time slot (a second slot T2 of FIG. 5) other than a time slot T1 with a predetermined slot number i which is described in the slot information S6, with reference to the time of the timestamp.

The transmission control unit 32A of the on-vehicle wireless device 3 stores vehicle data S4 including the time information, location information, direction, speed, and the like, of a vehicle 5 (the on-vehicle wireless device 3) in a communication frame, and radio-transmits the communication frame by broadcast through the communication unit 31.

The data relay unit 32B of the on-vehicle wireless device 3 can perform a relaying process where predetermined data is extracted from a communication frame received by the communication unit 31 and a transmission frame including the extracted data is transmitted by the communication unit 31.

For example, the data relay unit 32B extracts traffic information S2 or vehicle data S4 of another vehicle 5 from a communication frame received from a roadside wireless device 2, generates a communication frame including the extracted data, and allows the communication unit 31 to transmit the communication frame.

In addition, when a communication frame received from a roadside wireless device 2 or a communication frame received from another vehicle 5 includes slot information S6, the data relay unit 32B extracts the slot information S6 and temporarily stores the slot information S6 in the storage unit 33, and also stores the slot information S6 in a communication frame and allows the communication unit 31 to transmit the communication frame.

The control unit 32 of the on-vehicle wireless device 3 can perform safe driving support control that avoids right turn collisions, intersection collisions, etc., based on the locations, speeds, directions, and the like, of vehicles 5 which are included in vehicle data S4 directly received from other vehicles 5 (on-vehicle wireless devices 3) or in vehicle data S4 of other vehicles 5 received from roadside wireless devices 2.

<Frame Format for Vehicle-to-Vehicle Communication>

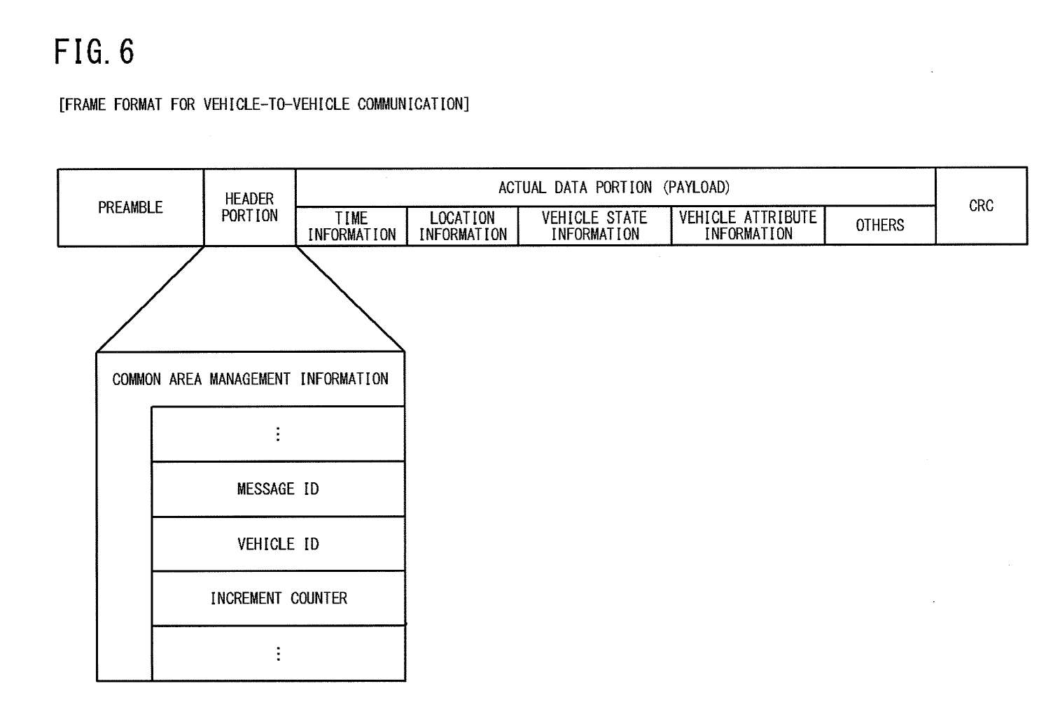

FIG. 6 is a diagram showing a frame format of a communication frame used for vehicle-to-vehicle communication.

The frame format of FIG. 6 is a frame format conforming to the “700 MHz BAND INTELLIGENT TRANSPORT SYSTEMS—Experimental Guideline for Inter-vehicle Communication Messages ITS FORUM RC-013 Ver. 1.0” (established on Mar. 31, 2014).

The above-described standard stipulates a “common area” which is obliged to be stored in all communication frames (the same as the “messages” referred to in the standard) and a “free area” which is arbitrarily stored. The free area can be freely defined by a user, and thus, in the frame format of FIG. 6, only portions related to the common area are described.

As shown in FIG. 6, a communication frame includes a “preamble”, a “header portion”, an “actual data portion (payload)”, and a “CRC (Cyclic Redundancy Check)”.

The “header portion” includes “common area management information” which is basic management information of data to be stored in the common area. The “common information management information” includes a “message ID”, a “vehicle ID”, an “increment counter”, and the like.

The “message ID” stores an identification value of the type of the communication frame (message). The “vehicle ID” stores an identification value of a vehicle 5 which is the generator of vehicle data S4. The “increment counter” stores a number value indicating the transmission order of the communication frame.

When an on-vehicle wireless device 3 transfers a communication frame by vehicle-to-vehicle communication, the on-vehicle wireless device 3 increments a value stored in an increment counter of the communication frame by one for each transfer.

Therefore, the receiving end of the communication frame can determine, by the number value of the increment counter, whether the received communication frame is a communication frame directly received from the generator or a communication frame indirectly received by a transfer.

The receiving end of communication frames can also determine the identicalness of data content of the received communication frames, based on both the identification value of a vehicle ID (hereinafter, also referred to as a “vehicle ID value”) and the number value of an increment counter (hereinafter, also referred to as a “counter value”).

Namely, when two communication frames with the same vehicle ID value and the same counter value are received, the receiving end of the communication frames can determine that the two communication frames have the same data content.

The “actual data portion” includes “time information”, “location information”, “vehicle state information”, “vehicle attribute information”, and “other information”.

The “time information” stores a time value at which the vehicle 5 fixes data content to be stored in the communication frame. The “location information” stores values such as a latitude, a longitude, and an altitude associated with the time value. The “vehicle state information” stores values such as a vehicle speed, a vehicle azimuth angle, and longitudinal acceleration associated with a time point value. The “vehicle attribute information” stores identification values such as a vehicle size type (a full-size car, a standard-size car, or the like), a vehicle use type (a private vehicle, an emergency vehicle, or the like), a vehicle width, and a vehicle length.

The “other information” stores optional information such as detailed information or supplementary information about the information stored in the common area. Therefore, storing of data in the other information is arbitrary.

For example, information to be stored in the other information includes “optional location information” which is optional information of the “location information”. The optional location information stores the value of a reliability index (the major and minor axes of a horizontal error ellipse, etc.) of a location obtained by the vehicle 5 through GPS. The receiving end of the communication frame can determine the accuracy of the location information by the magnitude of the index value.

<Transmission Format for Uplink Transmission>

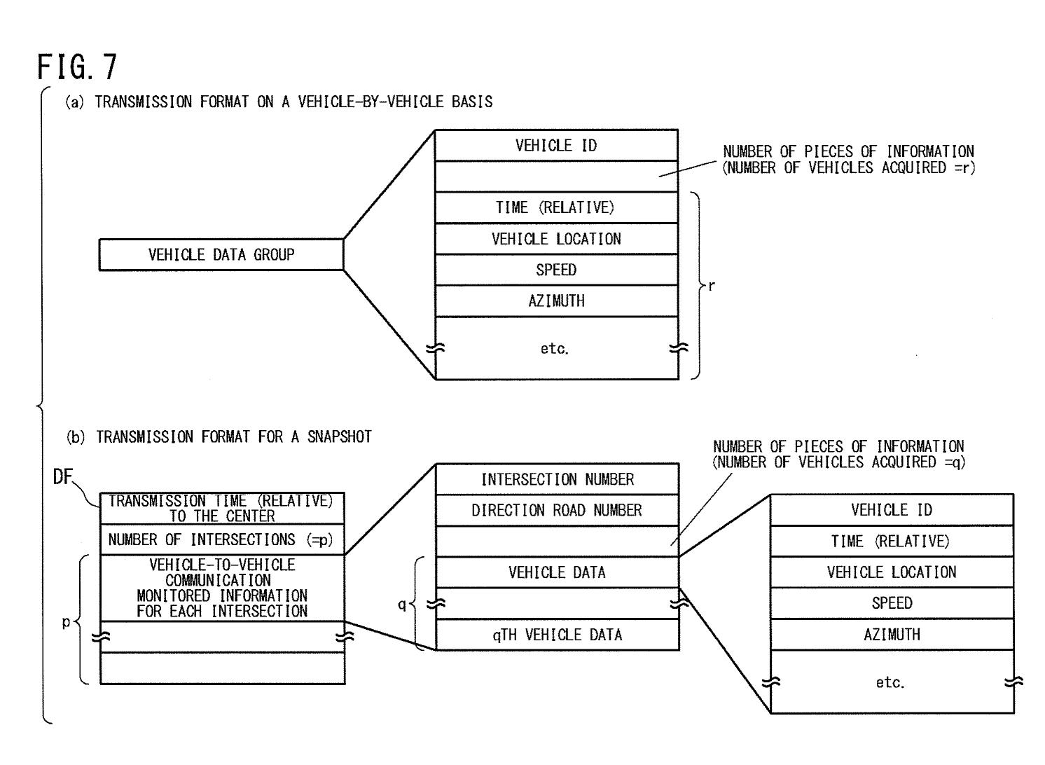

FIGS. 7(a) and 7(b) are diagrams showing the data formats of vehicle data S4 used upon uplink transmission. Specifically, FIG. 7(a) shows a “transmission format on a vehicle-by-vehicle basis” and FIG. 7(b) shows a “transmission format for a snapshot”.

A control unit 23 (specifically, a data relay unit 23C) of a roadside wireless device 2 converts vehicle data S4 obtained through reception of radio waves by vehicle-to-vehicle communication into a data format for uplink transmission, using either one of the above-described transmission formats, and relays the vehicle data S4 to the central apparatus 4.

Here, when a roadside wireless device 2 that has directly obtained vehicle data S4 from a vehicle 5 is a “roadside wireless device X” and a roadside wireless device 2 that performs roadside-to-roadside communication with the roadside wireless device X by radio is a “roadside wireless device Y”, the following two routes are assumed for uplink transmission of the vehicle data S4:

Route 1: Roadside wireless device X→communication lines→central apparatus

Route 2: Roadside wireless device X→roadside wireless device Y→communication lines→central apparatus

In the case of route 1, the roadside wireless device X performs the above-described data format conversion.

In the case of route 2, the following cases are considered: a case (first case) in which the roadside wireless device X performs data format conversion and the roadside wireless device Y does not perform data format conversion, and a case (second case) in which the roadside wireless device X in route 2 does not perform data format conversion but the roadside wireless device Y performs data format conversion.

The first case is a case in which the roadside wireless device 2 having directly obtained the vehicle data S4 from the vehicle 5 converts the data format.

The second case is a case in which the data format is not converted in roadside-to-roadside communication, but the roadside wireless device 2 that sends out the vehicle data S4 to a communication line 7 converts the data format.

It is assumed that the roadside wireless devices 2 of the embodiment are wireless communication devices that can handle both the first and second cases.

The “transmission format on a vehicle-by-vehicle basis” of FIG. 7(a) is a system in which obtained pieces of vehicle data S4 are compiled on a per vehicle ID basis. Namely, the control unit 23 of the roadside wireless device 2 chronologically rearranges a plurality of pieces of vehicle data S4 with the same vehicle ID which are obtained within a predetermined compilation period (e.g., one to several seconds), in order of pieces of time information thereof and thereby generates a “vehicle data group” shown in the drawing.

The “vehicle data group” includes data such as a “vehicle ID”, the “number of pieces of information” (it is assumed that the number of vehicles acquired=r), a “time (relative)”, a “vehicle location”, a “speed”, and “azimuth” in this order from the top.

The “number of pieces of information” refers to the number of pieces of vehicle data S4 for a specific vehicle ID whose time values (the value of “time information” of FIG. 6) are within the compilation period. In the example shown in the drawing, since the number of pieces of information=r, the vehicle data group includes r “times (relative)” and pieces of data associated with the r “times (relative)”.

The “time (relative)” is an area that stores the time value of the vehicle data S4. Storage areas following this area, such as a “vehicle location”, a “speed”, and an “azimuth”, are areas that respectively store, for example, the values of location information, speed, and azimuth associated with the time value.

When the control unit 23 of the roadside wireless device 2 generates a vehicle data group using the transmission format on a vehicle-by-vehicle basis, the control unit 23 stores the generated vehicle data group in a communication frame that is destined for the central apparatus 4 and that conforms to a communication protocol used for roadside-to-roadside communication or used by the communication lines 7.

The communication unit 21, 22 of the roadside wireless device 2 uplink-transmits the above-described communication frame to another roadside wireless device 2 or the communication line 7.

The “transmission format for a snapshot” of FIG. 7(b) is a system in which a data file DF of pieces of vehicle data S4 obtained at the time point of uplink transmission to the central apparatus 4 is adopted as it is as transmit data to the central apparatus 4.

The data file DF in the example shown in the drawing includes a “transmission time (relative) to the center”, the “number of intersections” (here, it is assumed that the number of intersections=p), and “vehicle-to-vehicle communication monitored information for each intersection” (which may be hereinafter abbreviated as “monitored information”) in this order from the top.

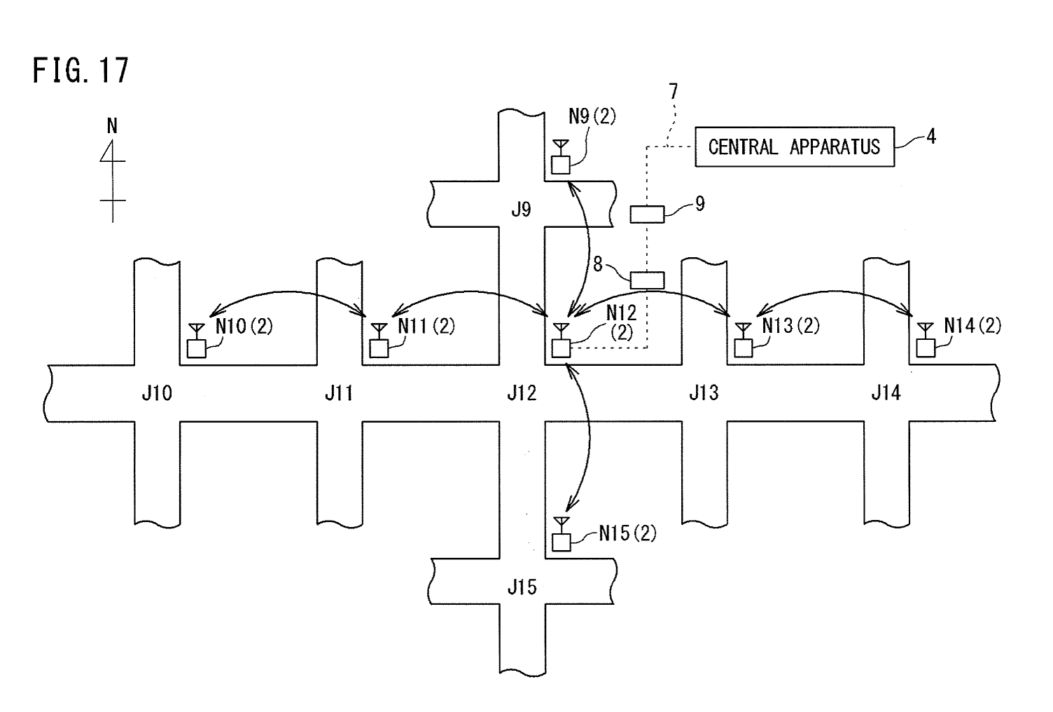

Note that the example of FIG. 7(b) assumes a case (see FIG. 17) in which one roadside wireless device 2 functions as a “master station” and uplink-transmits pieces of monitored information which are collected from other roadside wireless devices 2 (slave stations) by roadside-to-roadside communication, to the central apparatus 4.

The “transmission time (relative) to the center” refers to the transmission time of the data file DF. The “number of intersections” refers to the number of intersections where the roadside wireless device 2 serving as the master station has obtained pieces of monitored information by roadside-to-roadside communication. In the example shown in the drawing, the number of intersections=p, and thus, the data file DF includes pieces of monitored information for the p intersections.

The “vehicle-to-vehicle communication monitored information for each intersection” includes an “intersection number”, a “direction road number”, the “number of pieces of information” (it is assumed that the number of vehicles acquired=q), and q pieces of “vehicle data” in this order from the top.

The “intersection number” is an area that stores an identification value of an intersection where the monitored information is acquired. The “direction road number” is an area that stores an identification value indicating which direction's flow-in or flow-out road the road connected to the intersection is. The “number of pieces of information” is an area that stores the number of pieces of vehicle data S4 obtained at the intersection and on the direction road. In the example shown in the drawing, the number of information=q, and thus, the monitored information includes q pieces of vehicle data S4.

When the control unit 23 of the roadside wireless device 2 adopts the transmission format for a snapshot, the control unit 23 stores a data file DF obtained at the time point of uplink transmission in a communication frame that is destined for the central apparatus 4 and that conforms to a communication protocol used for roadside-to-roadside communication or used by the communication line 7.

The communication unit 21, 22 of the roadside wireless device 2 uplink-transmits the above-described communication frame to another roadside wireless device 2 or the communication line 7. Note that in this transmission format, the control unit 23 uplink-transmits a data file DF every predetermined period of time (e.g., one to several seconds).

In the transmission formats of FIGS. 7(a) and 7(b), by storing, as a data value stored in each data area, a difference value from the last value, the amount of data to be uplink-transmitted can be made compact.

In addition, data that has not been changed from the last transmission timing may not be transmitted and may be uplink-transmitted at a time point when a change has occurred. In this case, elapsed time (counter value) from before the change may be included as an information item.

<Thinning Process by the Data Relay Unit>

The control unit 23 (specifically, the data relay unit 23C) of the roadside wireless device 2 can perform at least one of the following first and second processes (hereinafter, collectively referred to as “thinning processes”) on obtained vehicle data S4.

First process: A process in which the amount of obtained vehicle data S4 is reduced and then the vehicle data S4 is relayed

Second process: A process in which some or all of an obtained plurality of pieces of vehicle data S4 are discarded without being relayed

The first process is a process of reducing the amount of data in units of vehicle data by removing some or all of data included in one piece of vehicle data S4.

This process includes, for example, a process in which in the frame format of FIG. 6, without removing the “time information” and the “location information” in the actual data portion, only minimum necessary data usable as probe data is left, and the “vehicle state information”, the “vehicle attribute information”, and the “other information” are removed. However, all information in the actual data portion may be removed.

The second process is a process of reducing the amount of vehicle data S4 in units of groups by discarding some or all of pieces of vehicle data S4 in a group of pieces of vehicle data S4 obtained during a predetermined period or a predetermined number of pieces of vehicle data S4, without relaying them.

This process includes, for example, a process in which a cycle period with a predetermined cycle (e.g., several seconds) is defined and from among a group where pieces of time information of pieces of vehicle data S4 are included in a specific cycle period, some or all of the pieces of vehicle data S4 are discarded at a predetermined ratio.

The control unit 23 of the roadside wireless device 2 performs at least one of the above-described first and second processes.

Note that although the above-described description of the thinning processes assumes a case in which a target of the thinning processes is vehicle data S4, the control unit 23 of the roadside wireless device 2 can also perform the same thinning process on data information obtained from pedestrians' portable terminals.

The control unit 23 of the roadside wireless device 2 may perform a predetermined compression process on remaining uplink information to be relayed after a thinning process.

By doing so, the amount of data to be uplink-transmitted to the central apparatus 4 is further reduced, and thus, the overload of the communication lines 7 can be more effectively suppressed.

### First Embodiment

<Main Point of the First Embodiment>

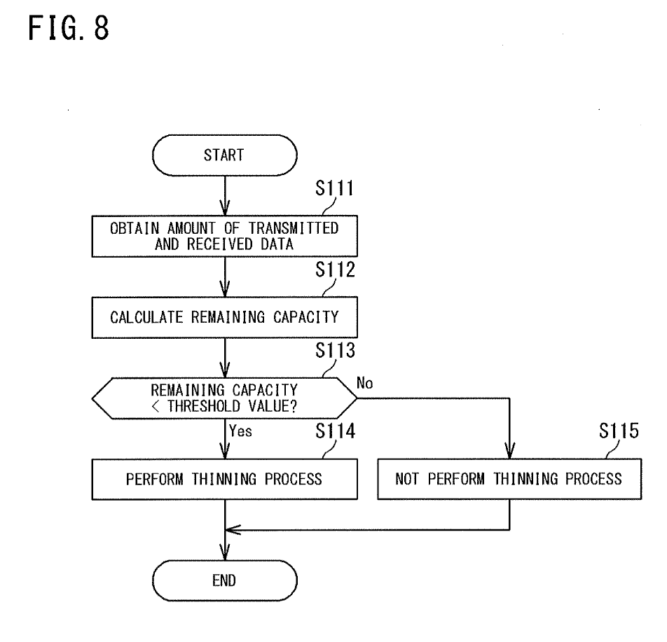

A roadside wireless device 2 of the first embodiment (FIGS. 8 to 14) performs a thinning process based on one-stage (one) determination condition, when relaying vehicle data S4.

Namely, the control unit 23 of the roadside wireless device 2 determines whether to perform a thinning process, based on one determination condition included in a control instruction from the central apparatus 4, and performs a relaying process of vehicle data S4 based on the determination result.

Determinations for a thinning process exemplified in FIGS. 8 to 11 and 13 are made as to whether to perform a thinning process, using all obtained pieces of vehicle data S4 as thinning targets.

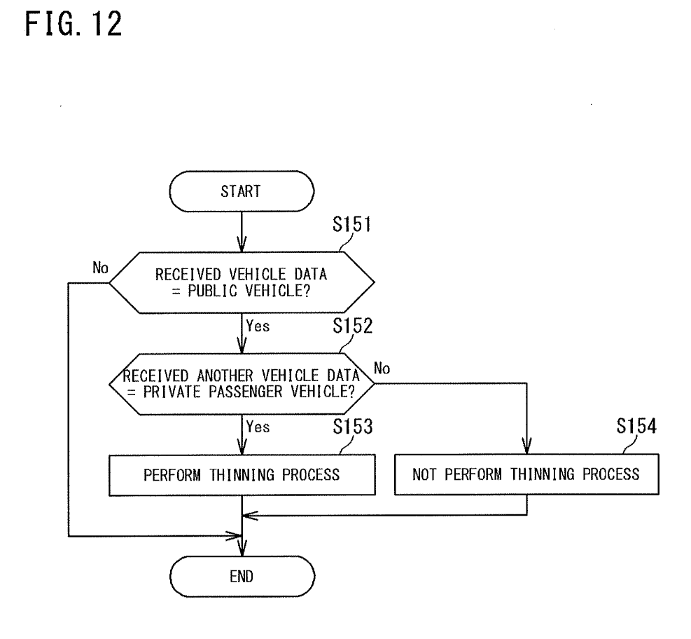

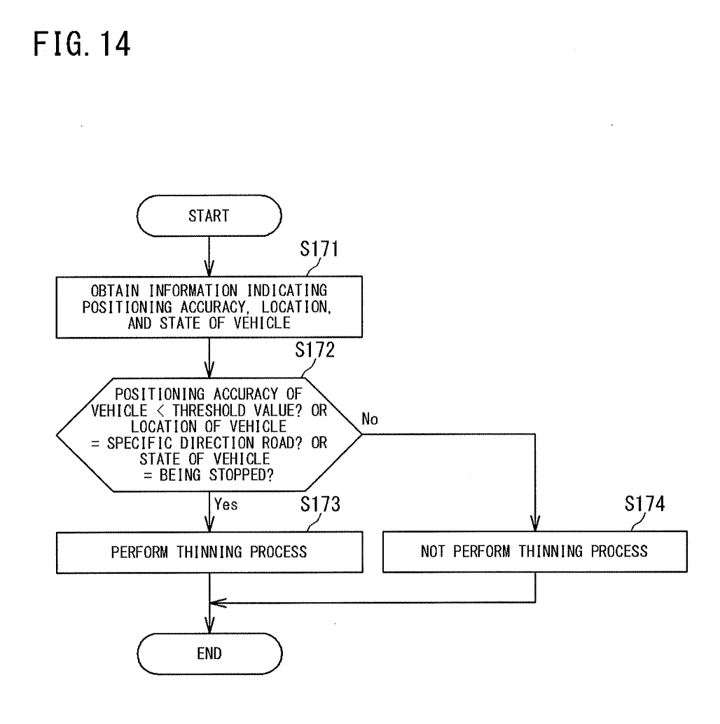

Determinations for a thinning process exemplified in FIGS. 12 and 14 are made as to whether to perform a thinning process, using individual obtained pieces of vehicle data S4 as thinning targets.

Note that although, here, determination conditions exemplified in FIGS. 8 to 14 are described for a case in which they are used alone, it is also possible to use two or more determination conditions in combination.

### Implementation Example 1 of the First Embodiment

FIG. 8 is a flowchart showing the content of a thinning determination process which is performed by the control unit 23 of the roadside wireless device 2 in implementation example 1 of the first embodiment.

In implementation example 1, the control unit 23 (specifically, the thinning determining unit 23B) of the roadside wireless device 2 performs a thinning determination process for vehicle data S4 using a determination condition set based on the communication conditions of communication lines 7 between the roadside wireless device 2 and the central apparatus 4.

Specifically, the control unit 23 first obtains from the central apparatus 4 the amount of data of a signal control instruction S1, vehicle data S4, various types of information S2, S3, S5, and S6, and the like, which are transmitted and received between the roadside wireless device 2 and the central apparatus 4 on a communication line 7 between the router 9 and the central apparatus 4 (see FIG. 2) which is a communication line most likely to become overloaded (step S111).

Note that the above-described amount of data may be directly obtained from the amount of data to be transmitted and received by the roadside wireless device 2.

Then, the control unit 23 calculates a value obtained by subtracting the obtained amount of data from the line capacity of the above-described communication line 7, as the remaining capacity of the communication line 7 (step S112).

Then, the control unit 23 determines whether the calculated remaining capacity is less than a threshold value (step S113).

If the determination result at step S113 is positive, the control unit 23 determines to perform a thinning process and ends the process (step S114).

If the determination result at step S113 is negative, the control unit 23 determines not to perform a thinning process and ends the process (step S115).

By the above determination, when the remaining capacity of the communication line 7 is less than the threshold value, the control unit 23 performs a thinning process of vehicle data S4, by which the communication line 7 can be suppressed from becoming overloaded.

In addition, when the remaining capacity of the communication line 7 is greater than or equal to the threshold value, i.e., when the communication line 7 has large remaining capacity, the control unit 23 does not perform a thinning process of vehicle data S4, by which more vehicle data S4 can be collected.

### Implementation Example 2 of the First Embodiment

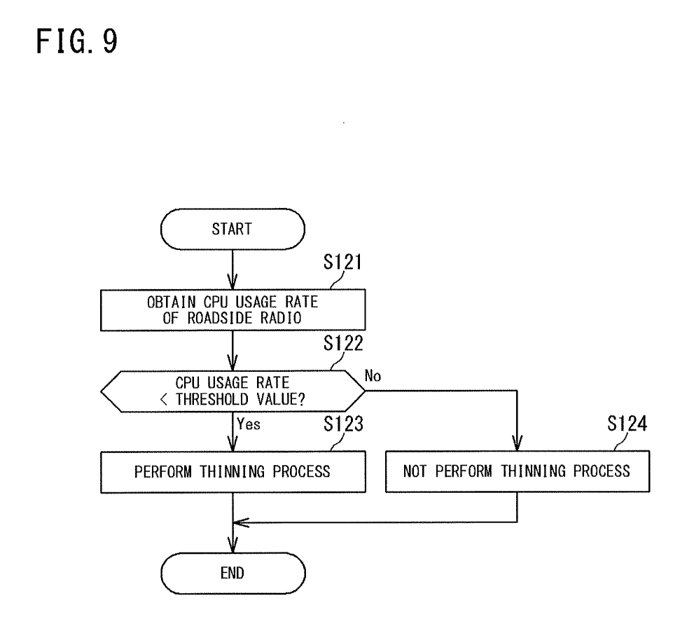

FIG. 9 is a flowchart showing the content of a thinning determination process which is performed by the control unit 23 of the roadside wireless device 2 in implementation example 2 of the first embodiment.

In implementation example 2, the control unit 23 of the roadside wireless device 2 performs a thinning determination process for vehicle data S4 using a determination condition set based on the communication processing load of the roadside wireless device 2.

Specifically, the control unit 23 first obtains, for example, a CPU usage rate per unit time of the control unit 23, as the amount of processing load for communication control such as roadside-to-roadside communication and roadside-to-vehicle communication (step S121).

Then, the control unit 23 determines whether the obtained CPU usage rate is less than a threshold value (step S122).

If the determination result at step S122 is positive, the control unit 23 determines to perform a thinning process and ends the process (step S123).

If the determination result at step S122 is negative, the control unit 23 determines not to perform a thinning process and ends the process (step S124).

By the above determination, when the amount of processing load for communication control by the control unit 23 is less than the threshold value, i.e., when there is room to perform a thinning process other than communication control, the control unit 23 performs a thinning process, and thus, vehicle data S4 can be securely thinned. By this, the communication lines 7 can be securely suppressed from becoming overloaded.

In addition, when the amount of processing load for communication control by the control unit 23 is greater than or equal to the threshold value, i.e., there is no room to perform a thinning process other than communication control, the control unit 23 does not perform a thinning process, and thus, more vehicle data S4 can be collected.

### Implementation Example 3 of the First Embodiment

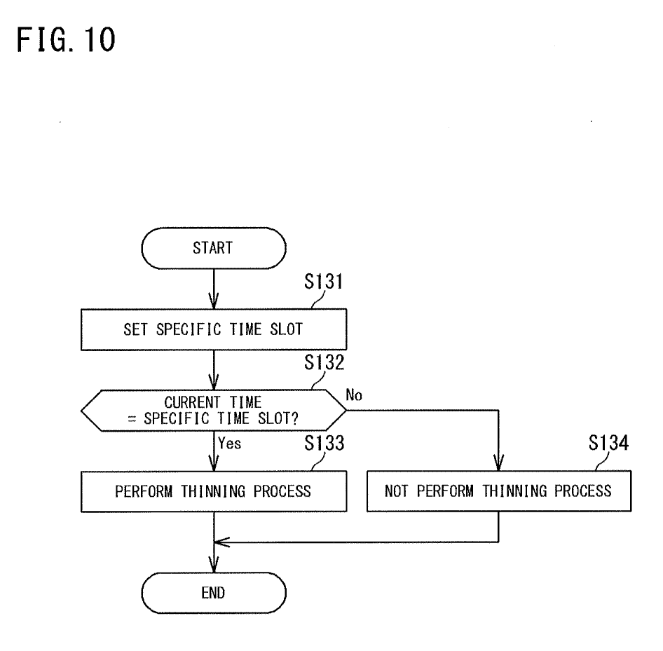

FIG. 10 is a flowchart showing the content of a thinning determination process which is performed by the control unit 23 of the roadside wireless device 2 in implementation example 3 of the first embodiment.

In implementation example 3, the control unit 23 of the roadside wireless device 2 performs a thinning determination process for vehicle data S4 using a determination condition set based on a specific time slot.

Specifically, the control unit 23 first obtains a specific time slot which is preset by the central apparatus 4 (step S131). The time slot is set to a time slot with a large amount of traffic on roads near an intersection where the roadside wireless device 2 is installed (e.g., a period between 05:00 and 23:00 on weekdays).

Note that the above-described time slot may be recorded in advance in the storage unit 24 of the roadside wireless device 2.

Then, the control unit 23 determines whether the current time is included in the above-described time slot (step S132).

If the determination result at step S132 is positive, the control unit 23 determines to perform a thinning process and ends the process (step S133).

If the determination result at step S132 is negative, the control unit 23 determines not to perform a thinning process and ends the process (step S134).

By the above determination, the control unit 23 performs a thinning process of vehicle data S4 during a time slot with a large amount of traffic on the roads, by which the communication lines 7 can be suppressed from becoming overloaded.

In addition, the control unit 23 does not perform a thinning process of vehicle data S4 during a time slot with a small amount of traffic on the roads such as weekday nighttime (e.g., a period between 23:00 and 05:00 on weekdays), by which more vehicle data S4 can be collected.

### Implementation Example 4 of the First Embodiment

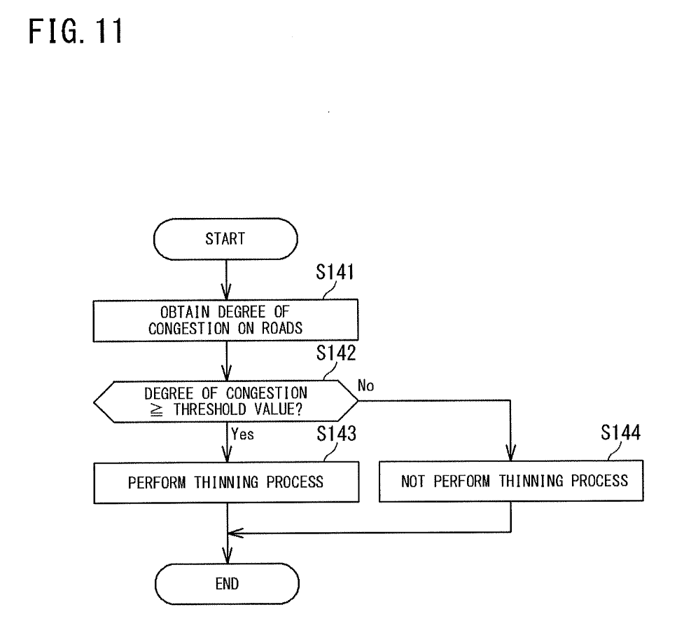

FIG. 11 is a flowchart showing the content of a thinning determination process which is performed by the control unit 23 of the roadside wireless device 2 in implementation example 4 of the first embodiment.

In implementation example 4, the control unit 23 of the roadside wireless device 2 performs a thinning determination process for vehicle data S4 using a determination condition set based on traffic jam conditions on roads.

Specifically, the control unit 23 first obtains from the central apparatus 4 the degree of congestion on roads near an intersection where the roadside wireless device 2 is installed (step S141). The degree of congestion indicates, in numerical values, the degree of congestion on the roads due to traffic jams and indicates that the larger the numerical value the larger the traffic jam scale. The degree of congestion can be converted into numbers by, for example, traffic parameters such as the amount of traffic, traffic jam length, and travel time.

Note that the roadside wireless device 2 may directly obtain the degree of congestion through detection information S5 of a roadside detector 6, etc.

Then, the control unit 23 determines whether the obtained degree of congestion on the roads is greater than or equal to a threshold value (step S142).

If the determination result at step S142 is positive, the control unit 23 determines to perform a thinning process and ends the process (step S143).

If the determination result at step S142 is negative, the control unit 23 determines not to perform a thinning process and ends the process (step S144).

By the above determination, when the degree of congestion on the roads is greater than or equal to the threshold value, i.e., when the roads are jammed up, the control unit 23 performs a thinning process of vehicle data S4, by which the communication lines 7 can be suppressed from becoming overloaded.

In addition, when the degree of congestion on the roads is less than the threshold value, i.e., when the roads are not jammed up, the control unit 23 does not perform a thinning process of vehicle data S4, by which more vehicle data S4 can be collected when no traffic jams.

Note that reversely to the above-described determination, the control unit 23 may determine to perform a thinning process of vehicle data S4 when the degree of congestion on the roads is less than the threshold value, and determine not to perform a thinning process of vehicle data S4 when the degree of congestion on the roads is greater than or equal to the threshold value.

In this case, since the control unit 23 does not perform a thinning process of vehicle data S4 when the roads are jammed up, more vehicle data S4 required to grasp traffic jam conditions, etc., can be collected.

### Implementation Example 5 of the First Embodiment

FIG. 12 is a flowchart showing the content of a thinning determination process which is performed by the control unit 23 of the roadside wireless device 2 in implementation example 5 of the first embodiment.

In implementation example 5, the control unit 23 of the roadside wireless device 2 performs a thinning determination process for vehicle data S4 using a determination condition set based on a specific vehicle.

Specifically, the control unit 23 first determines whether the generator of vehicle data S4 received by the wireless communication unit 21 is a public vehicle such an emergency vehicle or a fixed-route bus (step S151).

If the determination result at step S151 is negative, the control unit 23 ends the process without performing a determination process.

If the determination result at step S151 is positive, the control unit 23 transitions to the next step S152.

At step S152, the control unit 23 determines whether the generator of another vehicle data S4 received by the wireless communication unit 21 is a private passenger vehicle other than public vehicles.

If the determination result at step S152 is positive, the control unit 23 determines to perform a thinning process and ends the process (step S153).

If the determination result at step S152 is negative, the control unit 23 determines not to perform a thinning process and ends the process (step S154).

By the above determination, when vehicle data S4 is obtained from a public vehicle, the control unit 23 performs a thinning process for vehicle data S4 of private passenger vehicles and does not perform a thinning process for vehicle data S4 of public vehicles, by which more vehicle data S4 of public vehicles can be collected. By this, priority control where public vehicles are allowed to pass through on a priority basis, etc., can be securely performed.

### Implementation Example 6 of the First Embodiment

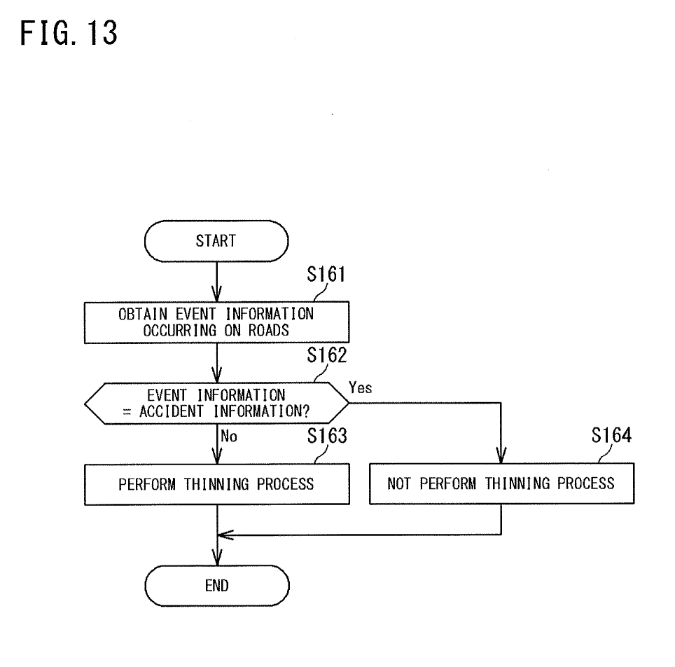

FIG. 13 is a flowchart showing the content of a thinning determination process which is performed by the control unit 23 of the roadside wireless device 2 in implementation example 6 of the first embodiment.

In implementation example 6, the control unit 23 of the roadside wireless device 2 performs a thinning determination process for vehicle data S4 using a determination condition set based on a specific event occurring on roads.

Specifically, the control unit 23 first obtains from the central apparatus 4 event information such as accident information or lane closure information occurring on roads near an intersection where the roadside wireless device 2 is installed (step S161).

The traffic control center where the central apparatus 4 is installed can obtain the event information from external reports.

Then, the control unit 23 determines whether the obtained event information is accident information (step S162).

If the determination result at step S162 is negative, the control unit 23 determines to perform a thinning process and ends the process (step S163).

If the determination result at step S162 is positive, the control unit 23 determines not to perform a thinning process and ends the process (step S164).

By the above determination, when an accident has occurred on a road, the control unit 23 does not perform a thinning process of vehicle data S4, by which more vehicle data S4 required to grasp the behavior, traffic jam conditions, etc., of vehicles which are different than usual on the road where the accident has occurred can be collected.

In addition, when no accident has occurred on a road, the control unit 23 performs a thinning process of vehicle data S4, by which the communication lines 7 can be suppressed from becoming overloaded.

Note that reversely to the above-described determination, the control unit 23 may determine not to perform a thinning process of vehicle data S4 when no accident has occurred on the roads, and determine to perform a thinning process of vehicle data S4 when an accident has occurred on the roads.

In this case, when an accident has occurred on a road, the road is expected to get congested, and thus, by the control unit 23 performing a thinning process of vehicle data S4, the communication lines 7 can be suppressed from becoming overloaded.

### Implementation Example 7 of the First Embodiment

FIG. 14 is a flowchart showing the content of a thinning determination process which is performed by the control unit 23 of the roadside wireless device 2 in implementation example 7 of the first embodiment.

In implementation example 7, the control unit 23 of the roadside wireless device 2 performs a thinning determination process for vehicle data S4 using a determination condition set based on the positioning accuracy, location, and state of a vehicle 5.

Specifically, the control unit 23 first obtains information indicating the positioning accuracy, location, and state of a vehicle 5 from vehicle data S4 received by the wireless communication unit 21 (step S171).

For the information indicating the positioning accuracy of the vehicle, optional location information that stores the value of a reliability index of a location obtained by the vehicle 5 through GPS can be used. For the information indicating the location of the vehicle, location information that stores values such as a latitude, a longitude, and an altitude can be used. For the information indicating the state of the vehicle, vehicle state information that stores values such as a vehicle speed, a vehicle azimuth angle, and longitudinal acceleration can be used.

Then, the control unit 23 determines, based on the above-described obtained information, whether any of the following conditions 1 to 3 is met (step S172):

Condition 1: The positioning accuracy of the vehicle is less than a threshold value

Condition 2: The location of the vehicle is on a specific direction road Condition 3: The state of the vehicle is “being stopped”

If the determination result at step S172 is positive, the control unit 23 determines to perform a thinning process and ends the process (step S173).

If the determination result at step S172 is negative, the control unit 23 determines not to perform a thinning process and ends the process (step S174).

By the above determination, when the positioning accuracy of the vehicle 5 is greater than or equal to the threshold value (when condition 1 is not met), the control unit 23 does not perform a thinning process of vehicle data S4, and thus, more vehicle data S4 with high positioning accuracy of vehicles 5 can be collected.

In addition, when the vehicle 5 is located on a specific direction road (e.g., a flow-in road of a main road) (when condition 2 is not met), the control unit 23 does not perform a thinning process of vehicle data S4, by which more vehicle data S4 of vehicles 5 traveling the specific direction road can be collected.

Note that the control unit 23 may determine not to perform a thinning process of vehicle data S4 when the vehicle 5 is located on the specific direction road, and determine to perform a thinning process of vehicle data S4 when the vehicle 5 is located on the specific direction road.

In this case, by the control unit 23 performing a thinning process of vehicle data S4 obtained from vehicles 5 that travel the specific direction road, the communication lines 7 can be suppressed from becoming overloaded.

In addition, the control unit 23 performs a thinning process of vehicle data S4 when, for example, the vehicle 5 is being stopped at an intersection, etc. (when condition 3 is met), and does not perform a thinning process of vehicle data S4 when the vehicle 5 is traveling (when condition 3 is not met), by which more vehicle data S4 obtained from traveling vehicles 5 can be collected.

### Second Embodiment

<Main Point of the Second Embodiment>

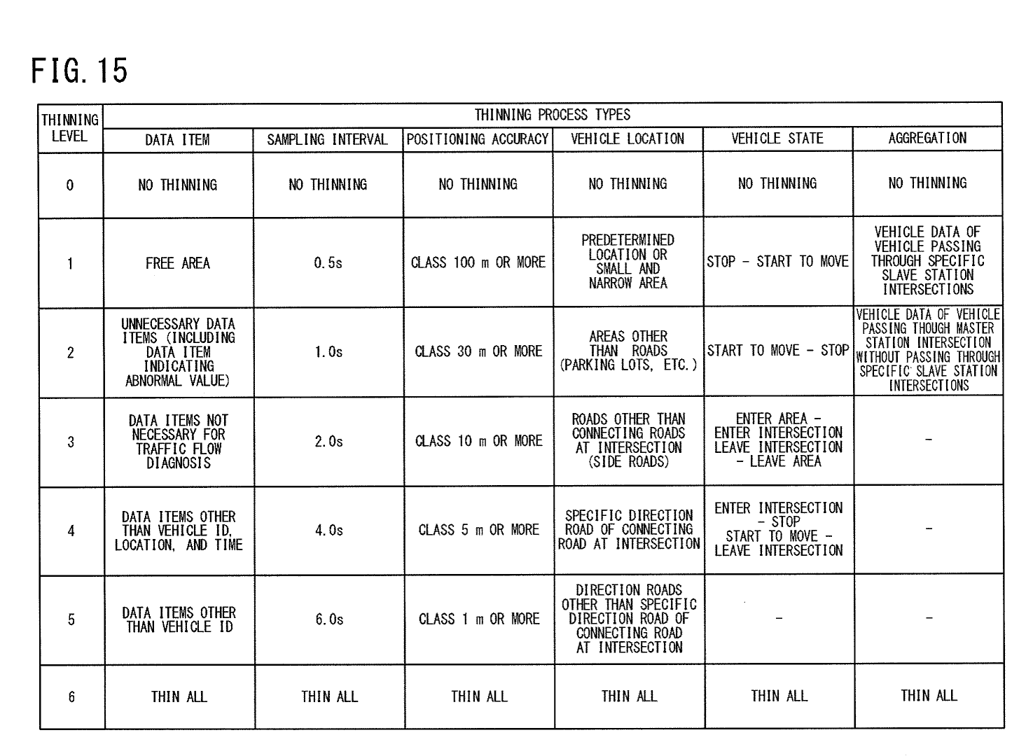

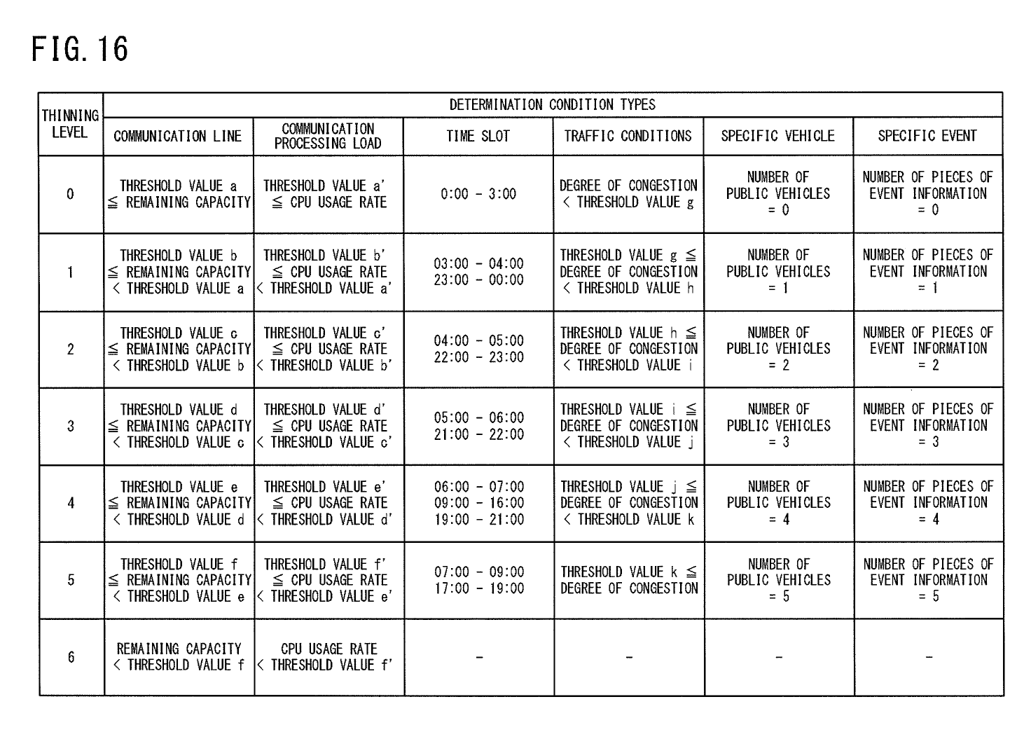

While a roadside wireless device 2 of the first embodiment performs a thinning process at one stage, a roadside wireless device 2 of the second embodiment (FIGS. 15 and 16) performs a thinning process at a plurality of stages.

Specifically, when the roadside wireless device 2 of the second embodiment relays vehicle data S4, the roadside wireless device 2 performs a plurality of thinning processes exemplified in FIG. 15, based on a plurality of determination conditions exemplified in FIG. 16.

FIG. 15 exemplifies a plurality of types (here, six types) of thinning processes, and each thinning process has different processing contents for a plurality of thinning levels.

FIG. 16 exemplifies a plurality of types (here, six types) of determination conditions, and each determination condition has different conditions set for a plurality of thinning levels.

Note that the thinning level in the embodiment gets higher as the value of the level gets larger, but may get higher as the value of the level gets smaller.

As shown in FIG. 15, the data relay unit 23C in the control unit 23 of the roadside wireless device 2 of the embodiment can perform thinning processes having a plurality of processing contents. These plurality of thinning processes have processing contents with different thinning levels where the amount of thinning increases gradually as the thinning level gets higher. Note that the plurality of thinning processes may have processing contents where the amount of thinning increases gradually as the thinning level gets lower.

As shown in FIG. 16, the thinning determining unit 23B in the control unit 23 determines whether to perform each thinning process, based on a plurality of determination conditions set for each of the plurality of thinning processes performed by the data relay unit 23C.

Therefore, the control unit 23 of the roadside wireless device 2 determines whether to perform each of the plurality of thinning processes, based on a plurality of determination conditions included in a control instruction from the central apparatus 4, and performs a relaying process of vehicle data S4 based on the determination results.

The control unit 23 of the roadside wireless device 2, for example, makes a determination for any one type of determination condition shown in FIG. 16, on a per thinning level basis, and thereby determines a thinning level that satisfies the determination condition. Then, the control unit 23 can perform a processing content of any one type of thinning process shown in FIG. 15 that corresponds to the determined thinning level.

Specifically, when, in FIG. 15, a “data item” thinning process is performed, the control unit 23 sets the thinning level of the “data item” thinning process to “1” or more (e.g., “2”) and sets other thinning processes to “no thinning” (thinning level=“0”).

Note that the control unit 23 may perform two or more types of thinning processes. In this case, the control unit 23 may set different thinning levels for the thinning processes. For example, in FIG. 15, the thinning level of a “data item” thinning process may be set to “1”, the thinning level of a “sampling interval” thinning process may be set to “2”, and other thinning processes may be set to “no thinning” (thinning level=“0”.

In addition, the control unit 23 may simultaneously use two or more types of determination conditions. In this case, when the control unit 23 determines that the determination conditions have different thinning levels, respectively, the control unit 23 may, for example, adjust the thinning levels to the maximum or minimum one or adjust the thinning levels to an average one.

Specifically, in FIG. 16, for example, in a case of simultaneously using the determination conditions “communication line” and “time slot”, when the control unit 23 determines the thinning level of “time slot” to be “5” and determines the thinning level of “communication line” to be “1”, since, though the communication line has reserve capacity under the present conditions, congestion is expected time-slot wise, the control unit 23 can set the thinning levels of “communication line” and “time slot” to “3” which is an average thinning level.

As such, the roadside wireless device 2 of the embodiment can perform a plurality of thinning processes having different processing contents, and thus can select and perform optimal thinning processes by which more vehicle data S4 can be collected, according to traffic conditions.

In addition, the roadside wireless device 2 of the embodiment can selectively perform a plurality of thinning processes where the amount of thinning of vehicle data S4 increases gradually as the thinning level gets higher. Thus, when the roadside wireless device 2 performs a thinning process of vehicle data S4, by performing a thinning process with a small amount of thinning, more vehicle data S4 can be collected.

<Thinning Process of the Second Embodiment>

FIG. 15 exemplifies six types of thinning processes: “data item”, “sampling interval”, “positioning accuracy”, “vehicle location”, “vehicle state”, and “aggregation”. Each thinning process exemplifies different processing contents for a plurality of thinning levels (here, seven thinning levels “0” to “6”). The processing contents of each thinning process will be described below with reference to FIG. 15.

Note that since the thinning levels “0” of the respective thinning processes are all set to “no thinning” and the thinning levels “6” are all set to “thin all”, in each thinning process, the thinning levels “1” to “5” will be described.

<Data Item>

A “data item” thinning process is such that some or all of a plurality of data items included in a data format of vehicle data S4 are removed, by which the amount of the vehicle data S4 to be uplink-transmitted is reduced. The amount of data of data items serving as removal targets in each thinning process is set so as to increase gradually as the thinning level gets higher (here, as the value of the level gets larger).

Specifically, in the case of the thinning level “1”, all data items in a free area (about 60 B) of the above-described data format are set as removal target data items. Since the free area is an area where the on-vehicle wireless device 3 side can freely set data items, and is less likely to be used for traffic control, etc., the free area is set as the first removal target of the vehicle data S4.

In the case of the thinning level “2”, in addition to the free area of the vehicle data S4, unnecessary data items (about 40 B) are set as removal targets. The unnecessary data items include, for example, a data item composed of intersection information. This is because the intersection information is known information that the central apparatus 4 also has, and thus does not need to be relayed to the central apparatus 4 from the roadside wireless device 2.

In addition, the unnecessary data items also include a data item indicating an abnormal value. For example, when a clock mounted on a vehicle that is the generator of vehicle data S4 is significantly slow, time information included in the vehicle data S4 of the vehicle is a data item indicating an abnormal value. In addition, all data items of vehicle data S4 of a vehicle that travels abnormally out of a normal traffic flow are data items indicating abnormal values.

In the case of the thinning level “3”, in addition to the free area and unnecessary data items of the vehicle data S4, data items (about 20 B) that are not necessary when the central apparatus 4 diagnoses a traffic flow are also set as removal targets.

In the case of the thinning level “4”, data items including the vehicle ID, location information, and time information of the vehicle data S4 (about 16 B) remain, and all other data items are set as removal targets.

In the case of the thinning level “5”, all data items excluding the vehicle ID (about 4 B) of the vehicle data S4 are set as removal targets. Note that the reason that only the vehicle ID of the vehicle data S4 remains is to grasp the number of vehicles flowing into the intersection.

As described above, in the “data item” thinning process, the amount of data of data items serving as removal targets is set so as to increase gradually as the thinning level gets higher. Thus, when vehicle data S4 is thinned, by setting a low thinning level, the amount of data of data items to be removed from the vehicle data S4 can be reduced. By this, the amount of vehicle data S4 to be uplink-transmitted can be increased, and thus, more vehicle data S4 can be collected.

<Sampling Interval>

A “sampling interval” thinning process is such that a sampling interval (time interval) at which vehicle data S4 is uplink-transmitted is increased, by which pieces of vehicle data S4 received by the roadside wireless device 2 during the sampling interval are discarded. A sampling interval serving as a thinning target of each thinning process is set so as to increase gradually as the thinning level gets higher.

Specifically, the sampling interval for the case of the thinning level “1” is set to 0.5 seconds. In this case, since vehicle data S4 is uplink-transmitted every 0.5 seconds, pieces of vehicle data S4 received during this period of 0.5 seconds are discarded.

In the case of the thinning levels “2” to “5”, their respective sampling intervals are set to 1.0 second, 2.0 seconds, 4.0 seconds, and 6.0 seconds.

As described above, in the “sampling interval” thinning process, the sampling interval at which vehicle data S4 is transmitted is set so as to increase gradually as the thinning level gets higher. Thus, when vehicle data S4 is thinned, by reducing the sampling interval by setting a low thinning level, the number of pieces of vehicle data S4 to be uplink-transmitted can be increased. By this, more vehicle data S4 can be collected.

<Positioning Accuracy>

A “positioning accuracy” thinning process is such that the level of positioning accuracy of a vehicle that is the generator of vehicle data S4 is set as a transmission condition of the vehicle data S4, by which vehicle data S4 that does not meet the transmission condition is discarded. The level of positioning accuracy of a vehicle can be obtained from information indicating the positioning accuracy of a vehicle which is included in vehicle data S4.

The level of positioning accuracy (hereinafter, referred to as target positioning accuracy) serving as a transmission condition of each thinning process is set so as to increase gradually as the thinning level gets higher.

Specifically, in the case of the thinning levels “1” to “5”, their respective levels of target positioning accuracy are represented using an accuracy error, and set to class 100 m or more, class 30 m or more, class 10 m or more, class 5 m or more, and class 1 m or more.

Here, the “class 100 m or more” refers to that it includes the levels of positioning accuracy higher than (accuracy errors smaller than) class 100, and includes class 30 m or more, class 10 m or more, class 5 m or more, and class 1 m or more.

Therefore, the “class 30 m or more” includes class 10 m or more, class 5 m or more, and class 1 m or more, and the “class 10 m or more” includes class 5 m or more and class 1 m or more. Then, the “class 5 m or more” includes class 1 m or more.

As described above, in the “positioning accuracy” thinning process, the level of target positioning accuracy serving as the transmission condition of vehicle data S4 is set so as to increase gradually as the thinning level gets higher. Thus, when vehicle data S4 is thinned, by reducing the target positioning accuracy by setting a low thinning level, the number of pieces of vehicle data S4 to be uplink-transmitted can be increased. By this, more vehicle data S4 can be collected.

<Vehicle Location>

A “vehicle location” thinning process is such that, when the location of a vehicle that is the generator of vehicle data S4 is included in a predetermined region, the vehicle data S4 obtained by the roadside wireless device 2 from the vehicle is discarded. The location of the vehicle can be obtained from location information included in the vehicle data S4.

The size of the predetermined region serving as a thinning target of each thinning process (hereinafter, referred to as a target predetermined region) is set so as to increase gradually as the thinning level gets higher.

Specifically, at the thinning level “1”, a predetermined location or a predetermined small and narrow area is set as the target predetermined region.

In the case of the thinning level “2”, areas other than roads, such as parking lots, are added to the target predetermined region with the thinning level “1”.

In the case of the thinning level “3”, roads excluding connecting roads at the intersection (e.g., side roads) are added to the target predetermined region with the thinning level “2”.

In the case of the thinning level “4”, a specific direction road of a connecting road at the intersection (e.g., a flow-out road of a sub-road) is added to the target predetermined region with the thinning level “3”.

In the case of the thinning level “5”, direction roads other than the above-described specific direction road of the connecting road at the intersection are added to the target predetermined region with the thinning level “4”.

As described above, in the “vehicle location” thinning process, the size of the target predetermined region serving as a thinning target is set so as to increase gradually as the thinning level gets higher. Thus, when vehicle data S4 is thinned, by reducing the target predetermined region by setting a low thinning level, the number of pieces of vehicle data S4 to be uplink-transmitted can be increased. By this, more vehicle data S4 can be collected.

Note that although in the above-described thinning process, the fact that the location of a vehicle is included in the predetermined region is set as the transmission condition of vehicle data S4, the fact that the location of a vehicle is not included in the predetermined region may be set as the transmission condition of vehicle data S4. In this case, the size of the predetermined region serving as the transmission condition of each thinning process may be set so as to decrease gradually as the thinning level gets higher.

<Vehicle State>

A “vehicle state” thinning process is such that vehicle data S4 obtained by the roadside wireless device 2 from a vehicle that is the generator of the vehicle data S4 in a predetermined number of event sections of the vehicle is discarded. An event of the vehicle can be obtained from vehicle state information and location information which are included in the vehicle data S4.

The number of the above-described event sections serving as thinning targets of each thinning process (hereinafter, referred to as target event sections) is set so as to increase gradually as the thinning level gets higher.

Specifically, in the case of the thinning level “1”, a section from a time point when the vehicle is stopped to a time point when the vehicle starts to move, i.e., a section where the vehicle is being stopped, is set as the first target event section. The reason that the section where the vehicle is being stopped is thus set as a target event section is because even if vehicle data S4 obtained from the vehicle while the vehicle is being stopped is discarded, by assuming that the vehicle is not moving, the behavior of the vehicle can be complemented.

In the case of the thinning level “2”, a section from a time point when the vehicle has started to move to a time point when the vehicle stops, i.e., a section where the vehicle is traveling, is set as the second target event section. The reason that the section where the vehicle is traveling is thus set as a target event section is because even if vehicle data S4 received from the vehicle while the vehicle is traveling is discarded, by assuming that the vehicle is moving at a constant velocity, the behavior of the vehicle can be complemented.

In the case of the thinning level “3”, a section from a time point when the vehicle has entered a communication area A (see FIG. 3) of the roadside wireless device 2 to a time point when the vehicle enters an intersection and a section from a time point when the vehicle has left the intersection to a time point when the vehicle leaves the communication area A are set as the third target event sections.

In the case of the thinning level “4”, a section from a time point when the vehicle has entered the intersection until the vehicle stops and a section from a time point when the vehicle has started to move to a time point when the vehicle leaves the intersection are set as the fourth target event sections.

As described above, in the “vehicle state” thinning process, the number of target event sections serving as thinning targets is set so as to increase gradually as the thinning level gets higher. Thus, when vehicle data S4 is thinned, by setting a low thinning level, the number of target event sections (sections where vehicle data is not transmitted) can be reduced. By this, the number of pieces of vehicle data S4 to be uplink-transmitted can be increased, and thus, more vehicle data S4 can be collected.

Note that in this thinning process, a target event section for the case of the thinning level “5” is not set, but a target event section may be set for the case of this thinning level, too.

Note also that four types of thinning processes with the thinning levels “1” to “4” can be set to any thinning level as long as the thinning level gets higher step-by-step within the range of the thinning levels “1” to “5”.

For example, the thinning levels of the above-described four types of thinning processes may be set to “2” to “5”, or may be set to “1”, “2”, “3”, and

<Aggregation>

An “aggregation” thinning process is used for an ITS radio system (communication system) including a plurality of communication nodes Ni, each composed of a roadside wireless device 2 that performs roadside-to-roadside communication and roadside-to-vehicle communication by radio, as shown in FIG. 17.

The ITS radio system shown in FIG. 17 includes a plurality of communication nodes N9 to N15 corresponding to intersections J9 to J15, respectively. Each communication node Ni is composed of a roadside wireless device 2 and can perform roadside-to-roadside communication with its adjacent communication nodes Ni.

Of the plurality of communication nodes N9 to N15, the communication node N12 is specified as a “master station” that is connected to the central apparatus 4 by a communication line 7, and other communication nodes N9 to N11 and N13 to N15 are specified as “slave stations”.

Therefore, pieces of vehicle data S4 obtained from vehicles 5 by the slave station communication nodes N9 to N11 and N13 to N15 are collected at the master station communication node N12 by roadside-to-roadside communication.

The master station communication node N12 uplink-transmits those pieces of vehicle data S4 collected from the slave station communication nodes N9 to N11 and N13 to N15 and those pieces of vehicle data S4 obtained on its own all at once to the central apparatus 4.

In FIGS. 15 and 17, the “aggregation” thinning process is such that upon uplink transmission of vehicle data S4 aggregated at the master station communication node N12, when a vehicle that is the generator of pieces of vehicle data S4 transferred from slave station communication nodes is traveling a predetermined number of traveling routes (moving routes), the pieces of vehicle data S4 are discarded. The traveling route of the vehicle can be obtained from time information and location information which are included in the vehicle data S4.

The number of the above-described traveling routes serving as thinning targets of each thinning process (hereinafter, referred to as target traveling routes) is set so as to increase gradually as the thinning level gets higher.

Specifically, in the case of the thinning level “1”, a traveling route where a vehicle passes through slave station intersections where specific slave station communication nodes are installed is set as a target traveling route.

For example, in FIG. 17, a traveling route (first traveling route) where a vehicle passes through the intersection J9 on the north side and the intersection J15 on the south side where the slave station communication nodes N9 and N15 are installed is set as the first target traveling route.

In this case, a traveling route of a vehicle that is the generator of pieces of vehicle data S4 received by the slave station communication nodes N9 and N15 in communication areas of the respective slave stations corresponds to a traveling route where the vehicle passes through the intersections J9 and J15, i.e., the first traveling route serving as a thinning target. Therefore, the pieces of vehicle data S4 of the vehicle are transferred to the master station communication node N12 from the communication nodes N9 and N15 and then discarded without being uplink-transmitted.

In the case of the thinning level “2”, a traveling route where a vehicle passes through a master station intersection where the master station communication node is installed, without passing through specific slave station intersections is set as the second target traveling route.

For example, in FIG. 17, a traveling route (second traveling route) where a vehicle passes through the intersection J12 where the master station communication node N12 is installed, without passing through either of the intersection J11 on the west side and the intersection J13 on the east side where the slave station communication nodes N11 and N13 are installed is added to the target traveling route with the thinning level “1”.

In this case, vehicle data S4 of a vehicle traveling the second traveling route is obtained by the communication node N12 in a communication area of its station, but is not obtained by the communication nodes N11 and N13 in communication areas of their stations. Hence, the vehicle data S4 of the vehicle traveling the second traveling route is not transferred from the slave station communication nodes N11 and N13, but is obtained by the master station communication node N12 on its own.

Therefore, vehicle data S4 that is not transferred from the slave station communication nodes N11 and N13 but is obtained by the master station communication node N12 on its own is discarded without being uplink-transmitted.

By this, vehicle data S4 transferred from the slave station communication nodes N11 and N13 to the master station communication node N12 can be relayed to the central apparatus 4 on a priority basis.

Therefore, the central apparatus 4 can handle pieces of vehicle data S4 of the same vehicle 5 as one piece of probe data collected over a long section from the intersection J11 (J13) to the intersection J12 on the central side.

As described above, in the “vehicle state” thinning process, the number of target traveling routes serving as thinning targets is set so as to increase gradually as the thinning level gets higher. Thus, when vehicle data S4 is thinned, by reducing the number of target traveling routes by setting a low thinning level, the number of pieces of vehicle data S4 to be uplink-transmitted can be increased. By this, more vehicle data S4 can be collected.

Note that in this thinning process, a target traveling route for the case of the thinning levels “3” to “5” is not set, but a target traveling route may be set for the case of these thinning levels, too.

Note also that two types of thinning processes with the thinning levels “1” and “2” can be set to any thinning level as long as the thinning level gets higher step-by-step within the range of the thinning levels “1” to “5”.

For example, the thinning levels of the above-described two types of thinning processes may be set to “3” and “4”, or may be set to “2” and “5”.

### Determination Conditions of the Second Embodiment

FIG. 16 exemplifies six types of determination conditions: “communication line”, “communication processing load”, “time slot”, “traffic conditions”, “specific vehicle”, and “specific event”. Each determination condition exemplifies different conditions for a plurality of thinning levels (here, seven thinning levels “0” to “6” at the maximum). Each determination condition will be described below with reference to FIG. 16.

<Communication Line>

A “communication line” determination condition is that the determination condition of the first implementation example of the first embodiment is divided into more detailed conditions. Here, the determination condition is that the thinning level gets higher as the remaining capacity of the communication line 7 (=line capacity−the amount of data) decreases. By this, the amount of thinning can be increased as the remaining capacity of the communication line 7 decreases.

The determination conditions for the respective thinning levels are set as follows:

Thinning level “0”: Threshold value a remaining capacity

Thinning level “1”: Threshold value b remaining capacity<threshold value a

Thinning level “2”: Threshold value c remaining capacity<threshold value b

Thinning level “3”: Threshold value d<remaining capacity<threshold value c

Thinning level “4”: Threshold value e remaining capacity<threshold value d

Thinning level “5”: Threshold value f remaining capacity<threshold value e

Thinning level “6”: Remaining capacity<threshold value f Here, the threshold values a to f satisfy the relationship of a>b>c>d>e>f.

<Communication Processing Load>

A “communication processing load” determination condition is that the determination condition of the second implementation example of the first embodiment is divided into more detailed conditions. Here, the determination condition is that the thinning level gets higher as the CPU usage rate which is the amount of processing load for communication control of the roadside wireless device 2 decreases. By this, the amount of thinning can be increased as the degree of room to perform a thinning process increases.

The determination conditions for the respective thinning levels are set as follows:

Thinning level “0”: Threshold value a′≦CPU usage rate

Thinning level “1”: Threshold value b′≦CPU usage rate<threshold value a′

Thinning level “2”: Threshold value c′ CPU usage rate<threshold value b′

Thinning level “3”: Threshold value d′≦CPU usage rate<threshold value c′

Thinning level “4”: Threshold value e′≦CPU usage rate<threshold value d′

Thinning level “5”: Threshold value f′≦CPU usage rate<threshold value e′

Thinning level “6”: CPU usage rate<threshold value f′

Here, the threshold values a′ to f′ satisfy the relationship of a′>b′>c′ >d′>e′>f′.

<Time Slot>

A “time slot” determination condition is that the determination condition of the third implementation example of the first embodiment is divided into more detailed conditions. Here, the determination condition is that the thinning level gets higher for a time slot with a larger amount of traffic. By this, the amount of thinning can be increased for a time slot with a larger amount of traffic.

The determination conditions for the respective thinning levels can be set, for example, as follows:

Thinning level “0”: 00:00 to 03:00

Thinning level “1”: 03:00 to 04:00 and 23:00 to 00:00

Thinning level “2”: 04:00 to 05:00 and 22:00 to 23:00

Thinning level “3”: 05:00 to 06:00 and 21:00 to 22:00

Thinning level “4”: 06:00 to 07:00, 09:00 to 16:00, and 19:00 to 21:00

Thinning level “5”: 07:00 to 09:00 and 17:00 to 19:00

<Traffic Conditions>

A “traffic conditions” determination condition is that the determination condition of the fourth implementation example of the first embodiment is divided into more detailed conditions. Here, the determination condition is that the thinning level gets higher as the degree of congestion on roads increases. By this, the amount of thinning can be increased as the traffic jam scale on roads increases.

The determination conditions for the respective thinning levels are set, for example, as follows:

Thinning level “0”: Degree of congestion<threshold value g

Thinning level “1”: Threshold value g≦degree of congestion<threshold value h

Thinning level “2”: Threshold value h≦degree of congestion<threshold value i

Thinning level “3”: Threshold value i≦degree of congestion<threshold value j

Thinning level “4”: Threshold value j≦degree of congestion<threshold value k

Thinning level “5”: Threshold value k≦degree of congestion

Here, the threshold values g to k satisfy the relationship of g<h<i<j<k.

Note that the “traffic conditions” determination condition is that the thinning level gets higher as the degree of congestion on roads increases; however, reversely, the determination condition may be that the thinning level gets higher as the degree of congestion on roads decreases.

<Specific Vehicle>

A “specific vehicle” determination condition is that the determination condition of the fifth implementation example of the first embodiment is divided into more detailed conditions. Here, the determination condition is that the thinning level gets higher as the number of public vehicles such as emergency vehicles or fixed-route buses increases. By this, the amount of thinning can be increased as the number of public vehicles, for example, increases.

The determination conditions for the respective thinning levels are set, for example, as follows:

Thinning level “0”: Number of public vehicles=0

Thinning level “1”: Number of public vehicles=1

Thinning level “2”: Number of public vehicles=2

Thinning level “3”: Number of public vehicles=3

Thinning level “4”: Number of public vehicles=4

Thinning level “5”: Number of public vehicles=5

<Specific Event>

A “specific event” determination condition is that the determination condition of the sixth implementation example of the first embodiment is divided into more detailed conditions. Here, the determination condition is that the thinning level gets higher as the number of pieces of event information such as accident information or lane closure information occurring on roads increases. By this, the amount of thinning can be increased as the number of accidents, for example, increases.

The determination conditions for the respective thinning levels are set, for example, as follows:

Thinning level “0”: Number of pieces of event information=0

Thinning level “1”: Number of pieces of event information=1

Thinning level “2”: Number of pieces of event information=2

Thinning level “3”: Number of pieces of event information=3

Thinning level “4”: Number of pieces of event information=4

Thinning level “5”: Number of pieces of event information=5

Note that the “specific event” determination condition is divided into conditions by the number of pieces of event information, but may be divided into conditions by the content of event information.

For example, the event information being accident information may be set as a determination condition with a high thinning level, and the event information being closure information may be set as a determination condition with a low thinning level.

In addition, when the event information is accident information, a large accident level may be set as a determination condition with a high thinning level, and a small accident level may be set as a determination condition with a low thinning level.

<Variant of the Determination Conditions of the Second Embodiment>

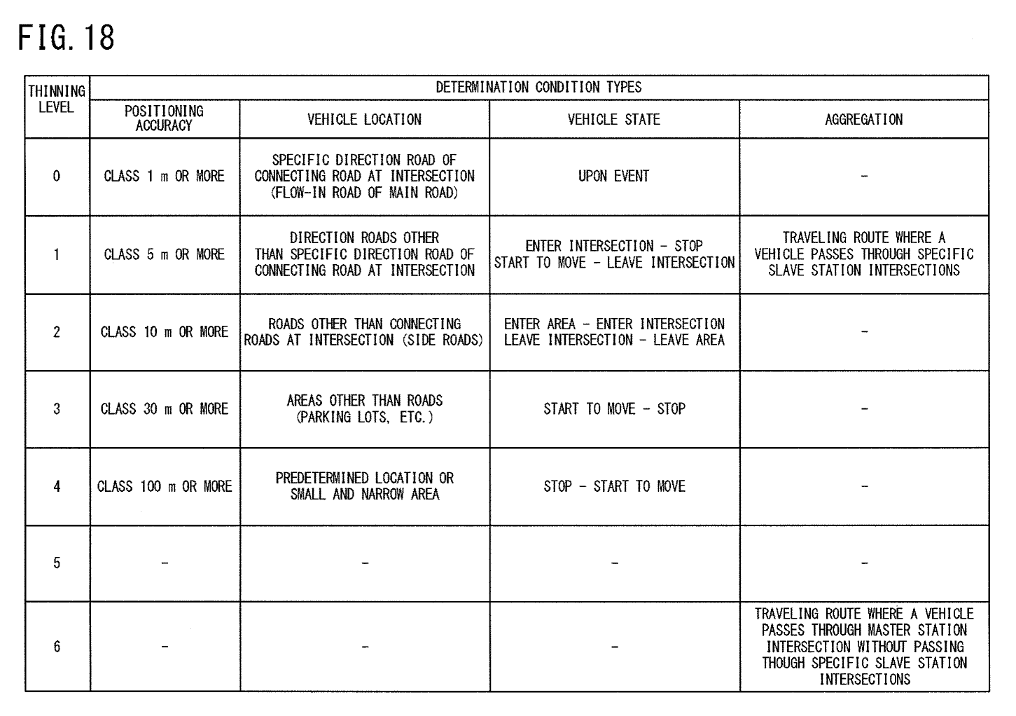

FIG. 18 is illustration showing a variant of the determination conditions of the second embodiment.

In the variant of FIG. 18, the “positioning accuracy”, “vehicle location”, “vehicle state”, and “aggregation” thinning processes exemplified in FIG. 15 are used as determination conditions.

Each determination condition exemplifies different conditions for a plurality of thinning levels (here, seven thinning levels “0” to “6” at the maximum). Each determination condition will be described below with reference to FIG. 18.

<Positioning Accuracy>

A “positioning accuracy” determination condition is that the thinning level gets higher as the level of positioning accuracy (accuracy error) of a vehicle that is the generator of vehicle data S4 decreases.

In this case, the higher the thinning level of the determination condition, the lower the positioning accuracy of a vehicle for vehicle data S4 satisfying the determination condition. Therefore, vehicle data S4 with low positioning accuracy of vehicles can be actively thinned.

The determination conditions for the respective thinning levels are set, for example, as follows:

Thinning level “0”: Positioning accuracy=class 1 m or more

Thinning level “1”: Positioning accuracy=class 5 m or more

Thinning level “2”: Positioning accuracy=class 10 m or more

Thinning level “3”: Positioning accuracy=class 30 m or more

Thinning level “4”: Positioning accuracy=class 100 m or more

<Vehicle Location>

A “vehicle location” determination condition is that the thinning level gets higher as the importance (the degree of necessity for traffic control, etc.) of the location of a vehicle that is the generator of vehicle data S4 decreases. Namely, in this determination condition, the higher the thinning level of the determination condition, the lower the degree of necessity for traffic control, etc., of vehicle data S4 satisfying the determination condition. Thus, vehicle data S4 that is not necessary for traffic control, etc., can be actively thinned.

The determination conditions for the respective thinning levels are set, for example, as follows:

Thinning level “0”: Vehicle location=a specific direction road of a connecting road at an intersection (e.g., a flow-in road of a main road)

Thinning level “1”: Vehicle location=direction roads other than the specific direction road of the connecting road at the intersection

Thinning level “2”: Vehicle location=roads other than connecting roads at the intersection (e.g., side roads)

Thinning level “3”: Vehicle location=areas other than roads (e.g., parking lots)

Thinning level “4”: Vehicle location=a predetermined location or a predetermined small and narrow area

<Vehicle State>

A “vehicle state” determination condition is that the thinning level gets higher as the importance (the degree of necessity for traffic control, etc.) of an event section of a vehicle that is the generator of vehicle data S4 decreases. Namely, in this determination condition, the higher the thinning level of the determination condition, the lower the degree of necessity for traffic control, etc., of vehicle data S4 satisfying the determination condition. Thus, vehicle data S4 that is not necessary for traffic control, etc., can be actively thinned.

The determination conditions for the respective thinning levels are set, for example, as follows:

Thinning level “0”: Vehicle state=upon an event (e.g., upon stopping or upon starting to move)

Thinning level “1”: Vehicle state=a section from a time point of entry to an intersection to a time point of stopping, or a section from a time point of starting to move to a time point when the vehicle leaves the intersection

Thinning level “2”: Vehicle state=a section from a time point of entry to a communication are A to a time point of entry to the intersection, or a section from a time point when the vehicle has left the intersection to a time point when the vehicle has left the communication area A

Thinning level “3”: Vehicle state=a section from a time point of starting to move to a time point of stopping

Thinning level “4”: Vehicle state=a section from a time point of stopping to a time point of starting to move

<Aggregation>

An “aggregation” thinning process is used for the ITS radio system shown in FIG. 17. The determination condition is that the thinning level gets higher as the importance (the degree of necessity for traffic control, etc.) of a traveling route of a vehicle that is the generator of vehicle data S4 decreases. Namely, in this determination condition, the higher the thinning level of the determination condition, the lower the degree of necessity for traffic control, etc., of vehicle data S4 satisfying the determination condition. Thus, vehicle data S4 that is not necessary for traffic control, etc., can be actively thinned.

The determination conditions for the respective thinning levels are set, for example, as follows:

Thinning level “2”: Traveling route=A traveling route where a vehicle passes through specific slave station intersections

Thinning level “6”: Traveling route=A traveling route where a vehicle passes through the master station intersection without passing through specific slave station intersections

Vehicle data S4 that meets the determination condition with the thinning level “6” is, as described in the “aggregation” thinning process, vehicle data that is not transferred from specific slave station communication nodes, but is obtained by the master station communication node on its own. Such vehicle data S4 is not used as one piece of probe data collected over a long section. Thus, even if the thinning level is set to high, there is no problem.

Note that in the “positioning accuracy”, “vehicle location”, and “vehicle state” determination conditions, determination conditions for the thinning levels “5” and “6” are not set, but determination conditions may be set for these thinning levels, too. Note also that for the “aggregation” determination condition, too, determination conditions may be set for the thinning levels “0” and “2” to “5” having no determination conditions set therefor.

In addition, the plurality of types of determination conditions exemplified in FIG. 18 can be set to any thinning level as long as the thinning level gets higher step-by-step within the range of the thinning levels “0” to “6”. For example, the thinning levels of two determination conditions with the thinning levels “2” and “6” in the “aggregation” determination condition may be set to “3” and “4”, for example.

<Other Variants>

Note that the embodiments disclosed here are to be considered in all respects as illustrative and not restrictive. The scope of the present invention is indicated by the claims rather than by the above-described meaning, and all changes which come within the meaning and range of equivalency of the claims are therefore intended to be embraced therein.

For example, although in the above-described embodiments the control unit 23 of the roadside wireless device 2 functions as a thinning determining unit, the control unit of the central apparatus 4 may function as a thinning determining unit, or both the control units of the roadside wireless device 2 and the central apparatus 4 may function as thinning determining units in cooperation with each other.

### REFERENCE SIGNS LIST

1: TRAFFIC SIGNAL UNIT
2: ROADSIDE WIRELESS DEVICE (ROADSIDE COMMUNICATION DEVICE)
3: ON-VEHICLE WIRELESS DEVICE
4: CENTRAL APPARATUS
5: VEHICLE
6: ROADSIDE DETECTOR
7: COMMUNICATION LINE
8: ROUTER
9: ROUTER
10: SIGNAL LIGHT UNIT
11: TRAFFIC SIGNAL CONTROLLER
12: SIGNAL CONTROL LINE
20: ANTENNA
21: WIRELESS COMMUNICATION UNIT
22: WIRED COMMUNICATION UNIT
23: CONTROL UNIT
23A: TRANSMISSION CONTROL UNIT
23B: THINNING DETERMINING UNIT (DETERMINING UNIT)
23C: DATA RELAY UNIT (RELAY UNIT)
24: STORAGE UNIT
30: ANTENNA
31: COMMUNICATION UNIT
32: CONTROL UNIT
32A: TRANSMISSION CONTROL UNIT
32B: DATA RELAY UNIT
33: STORAGE UNIT
A: COMMUNICATION AREA
Ji: INTERSECTION
Ni: COMMUNICATION NODE
S1: SIGNAL CONTROL INSTRUCTION
S2: TRAFFIC INFORMATION
S3: EXECUTION INFORMATION
S4: VEHICLE DATA
S5: DETECTION INFORMATION
S6: SLOT INFORMATION

1. A roadside communication device having a data relay function, the roadside communication device comprising:
a communication unit that receives mobile object data whose generator is a mobile object;
a determining unit that determines whether to perform a thinning process of an amount of the mobile object data received by the communication unit, based on a predetermined determination condition; and
a relay unit that relays the mobile object data with the thinning process when a result of the determination by the determining unit is positive, and relays the mobile object data without the thinning process when the result of the determination by the determining unit is negative.

2. The roadside communication device according to claim 1, wherein the predetermined determination condition includes a condition set based on communication conditions of a communication line to be used when the mobile object data is transmitted to a relay destination.

3. The roadside communication device according to claim 1, wherein the predetermined determination condition includes a condition set based on a communication processing load of the device.

4. The roadside communication device according to claim 1, wherein the predetermined determination condition includes a condition set based on a specific time slot.

5. The roadside communication device according to claim 1, wherein the predetermined determination condition includes a condition set based on traffic jam conditions on a road.

6. The roadside communication device according to claim 1, wherein the predetermined determination condition includes a condition set based on a specific mobile object.

7. The roadside communication device according to claim 1, wherein the predetermined determination condition includes a condition set based on a specific event occurring on a road.

8. The roadside communication device according to claim 1, wherein the predetermined determination condition includes a condition set based on at least one of positioning accuracy, a location, and a state of the mobile object.

9. The roadside communication device according to claim 1, wherein
the communication unit is capable of receiving a control instruction including the predetermined determination condition from an external device, and
the determining unit determines whether to perform the thinning process, based on the received control instruction.

10. The roadside communication device according to claim 1, wherein
the relay unit is capable of performing a plurality of thinning processes having different processing contents, and
the determining unit determines whether to perform each of the thinning processes, based on a plurality of predetermined determination conditions set for each of the plurality of thinning processes.

11. The roadside communication device according to claim 10, wherein the plurality of thinning processes have processing contents with different thinning levels, the processing contents being such that an amount of thinning increases gradually as a thinning level changes gradually.

12. The roadside communication device according to claim 11, wherein
the mobile object data received by the communication unit includes a plurality of data items,
the plurality of thinning processes include a process of removing a data item of a predetermined amount of data from the mobile object data, and
an amount of data of the data item serving as a removal target in the plurality of thinning processes is set so as to increase gradually as a thinning level of each of the thinning processes changes gradually.

13. The roadside communication device according to claim 11, wherein
the relay unit transmits the mobile object data to the relay destination at a predetermined time interval,
the plurality of thinning processes include a process of discarding at least some of a plurality of pieces of mobile object data received by the communication unit, by increasing the time interval, and
the time interval of the plurality of thinning processes is set so as to increase gradually as the thinning level of each of the thinning processes changes gradually.

14. The roadside communication device according to claim 11, wherein
the mobile object data received by the communication unit includes information indicating positioning accuracy of the mobile object, the mobile object being the generator of the mobile object data,
the plurality of thinning processes include a process of discarding at least some of a plurality of pieces of mobile object data received by the communication unit, by setting a level of the positioning accuracy as a transmission condition to the relay destination, and
the level of the positioning accuracy serving as the transmission condition in the plurality of thinning processes is set so as to increase gradually as the thinning level of each of the thinning processes changes gradually.

15. The roadside communication device according to claim 11, wherein
the mobile object data includes information indicating a location of the mobile object, the mobile object being the generator of the mobile object data,
the plurality of thinning processes include a process of discarding the mobile object data obtained from the mobile object, when the location of the mobile object is included in a predetermined region, and
a size of the predetermined region of the plurality of thinning processes is set so as to increase gradually as the thinning level of each of the thinning processes changes gradually.

16. The roadside communication device according to claim 11, wherein
the mobile object data includes information indicating an event of the mobile object, the mobile object being the generator of the mobile object data,
the plurality of thinning processes include a process of discarding mobile object data obtained, from the mobile object, in a predetermined number of event sections of the mobile object, and
a number of the event sections of the plurality of thinning processes is set so as to increase gradually as the thinning level of each of the thinning processes changes gradually.

17. The roadside communication device according to claim 11, wherein
the mobile object data includes information capable of identifying a moving route of the mobile object, the mobile object being the generator of the mobile object data,
the plurality of thinning processes include a process of discarding the mobile object data obtained from the mobile object, when the mobile object is moving on a predetermined number of moving routes, and
a number of the moving routes of the plurality of thinning processes is set so as to increase gradually as the thinning level of each of the thinning processes changes gradually.

18. A data relay method for a roadside communication device having a data relay function, the data relay method comprising:
a first step of receiving, by a communication unit of the roadside communication device, mobile object data whose generator is a mobile object;
a second step of determining, by a determining unit of the roadside communication device, whether to perform a thinning process of an amount of the mobile object data received by the communication unit, based on a predetermined determination condition; and
a third step of relaying, by a relay unit of the roadside communication device, the mobile object data with the thinning process when a result of the determination by the determining unit is positive, and relaying the mobile object data without the thinning process when the result of the determination by the determining unit is negative.
